(19) United States
(12) Patent Application Publication
(10) Pub. No.: US 2026/0265066 A1
(43) Pub. Date: Sep. 10, 2026

(54) A PROCESS FOR THE PURIFICATION OF GRAPHITIC MATERIAL

(71) Applicant: Hazer Group Limited, Perth, Western Australia (AU)

(72) Inventors: Andrew CORNEJO, Perth, Western Australia (AU); Anup Kumar ROY, Perth, Western Australia (AU); Victor Cheuk-Kit LO, Perth, Western Australia (AU); Benjamin CHIVERS, Perth, Western Australia (AU); Nikan NURB, Perth, Western Australia (AU)

(73) Assignee: Hazer Group Limited, Perth, Western Australia (AU)

(21) Appl. No.: 19/133,314

(22) PCT Filed: Dec. 2, 2022
(86) PCT No.: PCT/AU2022/051446

§ 371 Date: May 28, 2025

(51) Int. Cl. C01B 32/215; H01M 4/02; H01M 4/38; H01M 4/50; H01M 4/62; H01M 4/66; H01M 6/04

(52) U.S. Cl. CPC C01B 32/215; H01M 4/38; H01M 4/50; H01M 4/622; H01M 4/625; H01M 4/661; H01M 6/045; C01P 2002/72; C01P 2002/82; C01P 2002/88; C01P 2004/03; C01P 2006/40; C01P 2006/80; H01M 2004/027; H01M 2300/0011

(57) ABSTRACT

Provided herein is a process for purifying graphite comprising: electrochemically treating a graphite comprising an impurity selected from a metal, metal oxide and combinations thereof in the presence of an electrolyte; thereby removing a portion of the impurity as a result of the electrochemical treatment and providing a purified graphite. Also provided is purified graphite provided by such process, a negative electrode and a battery, each comprising said purified graphite.

### CROSS-REFERENCE TO RELATED APPLICATION

This Application is a U.S. National Phase of PCT Application No. PCT/AU2022/051446, file on Dec. 2, 2022, the entirety of which is incorporated herein by reference.

### FIELD OF THE INVENTION

The present invention relates to a process of purifying impurity-containing graphite. In particular, the present invention relates to a process of purifying impurity-containing graphitic material by removing impurities such as metals, metal oxides and combinations thereof. Suitably purified graphitic material has numerous applications including carbon brushes, refractories, material composites, electrodes, lubricants, coatings, transport, mechanical components, textiles, and household consumer applications.

In its most preferred form, the present invention specifically relates to a process for purifying graphite produced via the Hazer® Process, which produces iron-containing graphite of specific and selectable morphologies. However, it will be appreciated that the invention is not limited to this particular, most preferred field of use.

Another form of the invention relates to a purified graphite having a reduced concentration of metal and/or metal oxide impurity which can be produced by the process of the present invention.

### BACKGROUND OF THE INVENTION

Carbon, or more particularly graphite, is considered a key material in the emerging green technology market. It has been shown to be useful in energy storage, electrical conduction devices, catalyst supports, lubrication additives and modern electronics equipment.

Carbon has several different allotropes (i.e., different physical forms). Different carbon allotropes can have different physical properties. For example, diamond is the hardest naturally-occurring substance, and graphite is extremely soft, cleaves with very light pressure and has a very low specific gravity. Diamond is transparent, the ultimate abrasive and can be an electrical insulator and thermal conductor while graphite is opaque, a very good lubricant and is a good conductor of electricity while being an effective thermal insulator. Allotropes of carbon are not limited to diamond and graphite, but also graphene (a two-dimensional layer of crystalline carbon), amorphous carbon, glassy carbon, carbon nanofoam and other allotropes of carbon specifically related to the Hazer® Process, namely carbon nanotubes (CNTs), carbon nano-onions (CNOs), carbon microspheres (CMS) and the like.

Graphite has numerous applications including carbon brushes, refractories, material composites, electrodes, lubricants, coatings, transport, mechanical components, textiles, and household consumer applications. Recently, specialty markets for graphite have emerged, including batteries for electric vehicles (EVs); as EV sales grow, demand for battery grade graphite is expected to surge. Despite changes in battery chemistry, graphite is expected to remain a key element in EV batteries for at least the next decade. Both synthetic graphite and natural graphite, in the form of the intermediate product spherical graphite, are used in the anodes of lithium-ion batteries.

For certain applications, a highly pure graphite may be required. Additionally, as would be appreciated by a skilled addressee, a higher quality grade of graphite (i.e., purity) lends itself to specialty uses such as those described above. High purity graphite (99.9%) can be worth 5-10 times more than normal purified graphite (94%-98%).

The concept of purifying graphite is not new. Indeed, graphite beneficiation is practised widely on an industrial level. There are two ways of obtaining a commercial concentrate or product: (1) Flotation: repeated regrinding and floating (up to seven times) to purify the concentrate, or (2) by acid leaching (dissolving) the gangue with hydrofluoric acid (for a silicate gangue) or hydrochloric acid (for a carbonate gangue). Both methods rely on the impurity to be somewhat liberated or exposed from any graphite encapsulation, which limits the applicability for graphite that contains very small (nanometer scale) impurities. Acidic leaching can be a dangerous and polluting method. Further, it will be appreciated that crushing and flotation destroys the morphology of the purified graphite.

U.S. Pat. No. 2,787,528 discloses a process for purifying graphite with less than 3% ash. U.S. Pat. No. 2,787,528 discloses a process wherein the impure graphite is first treated with a solution of dilute sulfuric acid and is thereafter treated with a mild caustic agent. The principal impurities in most high-carbon natural graphite are micas.

U.S. Pat. No. 1,600,730 discloses methods of purifying and treating naturally-occurring graphite coming from mines using an electrolyser to remove a portion of natural impurities. The natural impurities in naturally-occurring graphite taken from a schistic geological formation, after mechanical purification, are silica, alumina, iron oxide, calcium oxide, magnesium oxide, sulfuric anhydride and divers alkalis. Notably, U.S. Pat. No. 1,600,730 does not disclose the purity of the graphite after treatment using an electrolyser.

The Hazer® Process has been shown to produce graphitic carbon with total graphitic carbon (TGC) of 70 to 97% w/w directly from the reactor. To appeal the high-end market of graphite applications, such as battery manufacturing, graphite purity of 99.9% or higher is required.

Table 1, below, shows the price of different graphite purities from 2013. As is readily apparent, increasing the purity of the graphitic material enhances the value of the product

TABLE 1
Price of graphite in USD/tonne from January 2013

| | | Average price |
|---|---|---|
| Graphite grade | | (USD/tonne) |
| Small flake | (95-98%) | $900-$1200 |
| Medium flake | (95-98%) | $1050-$1400 |
| Large flake | (95-98%) | $1400-$1800 |
| Jumbo flake | (95-98%) | >$1600 |
| Battery grade flake | (99.9%) | $5000-$20,000 |

International patent publication WO 2016/154666 describes the production of graphitic carbon via the Hazer® Process. Along with graphitic carbon, the process also produces hydrogen. The feedstock is a hydrocarbon gas, most preferably a methane source, and the process comprises contacting at a temperature between 600° C. and 1000° C. a low-grade iron oxide catalyst with the hydrocarbon gas to catalytically convert at least a portion of the hydrocarbon gas to hydrogen and graphitic carbon. The graphitic carbon is deposited over the low-grade iron oxide catalyst, and necessarily results in the graphite thus obtained having a degree of iron-based contamination.

International patent publication WO 2017/031529 describes subsequent refinements in and to the Hazer® Process, which results in graphitic species of various morphologies being selectively attainable. Because different morphologies of graphite exhibit different properties, commercial uses of graphite are also highly dependent on the morphology. According to the process described in WO 2017/031529, four distinct morphologies of graphite can be selectively produced.

Firstly, graphitic fibres, which are fibrous carbon structures typically ranging from 100 nm to 100 microns in length; the best-known graphitic fibres are carbon nano-tubes (CNTs), which are cylindrical nano-structures comprising single or multiple graphitic sheets aligned concentrically or perpendicular to a central axis.

Secondly, carbon nano-onions (CNOs), which are structures that consist of multiple spherical graphitic sheets that are concentrically layered from a central core, which is typically a catalyst particle or a void; these carbon structures typically range from 50-500 nm in diameter.

Thirdly, carbon micro-spheres (CMSs), which are hollow globular graphitic structures typically greater than 500 nm in size. They are globular in shape and can be chain-like. Naturally-occurring CMSs are found in meteorites.

Finally, the parameters of temperature and pressure can be manipulated within the Hazer Process to produce graphene, which is characterised by single-layer or single-digit layer sheets of graphite.

As with the earlier iteration of the technology described in WO 2016/154666, it will be appreciated that in using a low-grade iron oxide as catalyst (most preferably in the form of Fe₂O₃, Fe₃O₄, hematite ore or goethite ore), the graphite produced, irrespective or morphology, will contain iron-based impurities at a level that requires subsequent purification for its downstream use in many fledgling and established industries.

Previously, Hazer graphite has been successfully purified to >99.9% w/w using techniques including high temperature thermal purification, and microwave assisted acid digestion. However, these methods can be difficult to scale up and can be expensive.

It is an object of the present invention to overcome or ameliorate one or more of the disadvantages of the prior art, or at least to provide a useful alternative.

It is an object of a preferred form of the present invention to provide a process which can purify graphite having a high degree of purity (i.e., greater than 90% and even greater than 99%).

It is an object of at least one preferred form of the present invention to provide a process which can purify graphite without affecting the morphology or degrading the graphite.

Although the invention will be described with reference to specific examples, it will be appreciated by those skilled in the art that the invention may be embodied in many other forms.

### SUMMARY OF THE INVENTION

The present invention relates generally to a process for increasing the purity of Hazer graphite from 50% to 99.9% (by weight), preferably 80% to 99.7% by electrochemically extracting the iron impurity. As an additional advantage, it may be possible to recover the iron impurity as a high purity catalyst for the Hazer® Process. The experiments conducted by the inventors demonstrate that the electrochemical purification (ECP) process can purify graphite in both solid and slurry forms. However, the convenience associated with processing Hazer graphite as a slurry is likely to be at the expense of reaction rate and/or power consumption. Results further demonstrate the purification of Hazer graphite at gram scale and the potential for upscaling.

High-purity graphite finds use in numerous applications including carbon brushes, refractories, batteries, material composites, electrodes, lubricants, coatings, transport, mechanical components, textiles, and household consumer applications.

Chemical purification of naturally-occurring mined graphite has been used to remove natural impurities from geological formations. However, achieving a highly pure graphite regardless of source (i.e., naturally-occurring or synthetically-produced graphite) via economically-viable means has been problematic. However, some graphite samples (in particular, those produced via the Hazer® Process) have impurities that are heavily encapsulated in the graphitic material and thus are more difficult to remove. Fine milling is typically employed to liberate embedded impurities. However, this is not always practical or possible for nano-sized impurities (such as Hazer® Process graphite). The technique proposed by way of the present invention provides a means of addressing this issue.

According to a first aspect, the present invention provides a process for purifying graphitic material, the process comprising:
electrochemically treating a crude graphitic material comprising an impurity selected from a metal, metal oxide and combinations thereof;
using a predetermined or regenerative electrolyte;
over a predetermined period;
over a predetermined voltage range;
over a predetermined temperature range;
using a predetermined anode composition;
using a predetermined cathode composition;
thereby removing a portion of the impurity as a result of the electrochemical treatment and providing a purified graphitic material.

In an embodiment, the process employs a predetermined permeable membrane, which restrains the graphite from contacting the cathode, which can cause a short-circuiting.

In an embodiment, the impurity is selected from a metal, metal containing impurity, non-metal, non-metal containing impurity, organic, inorganic, and combinations thereof. In a preferred embodiment, the impurity is a non-carbon impurity. In an especially preferred embodiment, the impurity is a metal. Most preferably, the metal is iron or an iron-carbon species such as ferrite, austenite and cementite.

In another embodiment, the crude graphitic material is compressed prior to use in the process.

In another embodiment, wherein the process includes no stirring nor agitation.

In another embodiment, the metal containing impurity is selected from a metal oxide, metal hydroxide, metal nitrate, carbonate, carboxylic acid, salt, and the like.

In an embodiment, the purified graphitic material has a morphology substantially the same as that of the crude graphitic material. Preferably, the graphitic material has a morphology selected from graphitic fibres (including carbon nano-tubes), carbon nano-onions and carbon micro-spheres.

In an embodiment, the electrolyte is selected from metals or transition metals with sulfates, sulfites (including bisulfates), phosphates, carbonates, bicarbonates, hydroxides, permanganates, chromates, dichromates, oxalates, formates, acetates, benzoates, halides, chlorites, perchlorites and hypochlorites and the like (e.g., perfluorates, hypobromites, etc.), acids, and the like and mixtures thereof, for instance, sulfate and sulfuric acid. In an especially preferred embodiment, the electrolyte is ammonium sulfate, iron sulfate or a mixture thereof. In another embodiment, the electrolyte is sulfuric acid or nitric acid. Preferably, the electrolyte is iron sulfate or ammonium sulfate. Those skilled in the art will appreciate that it is possible to use any suitable salt provided that the salt or salts selected form a soluble compound and/or complex with iron and or metal impurities. In further embodiment, the electrolyte is selected from sulfides, phosphides, phenolates, superoxides, peroxides, oxides, silicates, sulfones, thiocyanates, thiosulfates, selenates, triiodides, azides, cyanides, cyanates, borates, fulminates, arsenates, vanadates, antimonates and the like.

In an embodiment, the iron impurity precipitates as iron dendrites on the cathode. Typically, the iron dendrites are harvested and applied industrially. In some embodiments, the iron dendrites are used as catalyst in the thermocatalytic decomposition of methane to hydrogen and iron-contaminated graphitic material. In other embodiments, the iron can be in the form of a sludge. In certain embodiments, the sludge can be recovered and refined and/or tuned to catalyst, for example low- or high-performing catalyst depending on the post-processing methodology. In a preferred embodiment, the sludge, once refined to produce an iron containing catalyst, can be used in the Hazer process to produce hydrogen and graphite from hydrocarbons, preferably methane.

In an embodiment, the iron impurity remains in solution. In an embodiment, the iron impurity is precipitated from solution to be used as catalyst in the thermocatalytic decomposition of methane to hydrogen and iron-contaminated graphitic material such as the Hazer® process.

The precipitated iron can have a specific shape, size and purity or composition (pure iron or a complex). The precipitation can be achieved as part of the cell or as a separate process.

In an embodiment, the iron impurity is precipitated from solution to be used as catalyst in the thermocatalytic decomposition of methane to hydrogen and iron-contaminated graphitic material. In an embodiment, the iron impurity, once precipitated, is dried, crushed, and/or filtered.

In an embodiment, the iron-contaminated graphitic material is subsequently purified by a process as defined according to the first aspect of the present invention.

In an embodiment, the process is performed on a continuous, substantially continuous or batch basis.

In certain embodiments, the process is performed on a batch basis with each batch comprising about 1 g to 3 kg of graphitic material. For example, each batch comprises about 1 g to about 10 g, or about 10 g to about 20 g, or about 20 g to about 30 g, or about 30 g to about 40 g, or about 40 g to about 50 g, or about 50 g to about 60 g. or about 60 g to about 70 g, or about 70 g to about 80 g, or about 80 g to about 90 g, or about 90 g to about 100 g, or about 100 g to about 200 g, or about 200 g to about 300 g, or about 300 g to about 400 g, or about 400 g to about 500 g, or about 500 g to about 600 g, or about 600 g to about 700 g, or about 700 g to about 800 g, or about 800 g to about 900 g, or about 900 g to about 1 kg, or about 1 kg to about 2 kg, or about 2 kg to about 3 kg of graphite material. In an embodiment, the process does not lose efficiency or loses minimal efficiency with the scale-up of the amount of graphitic material in each batch.

In an embodiment, the voltage range is between about 1 V and 300 V. Preferably, the voltage range is between about 5 and 300V. In a specific embodiment, the voltage is about 20 V. It was found that a voltage of 20 V increases purification over 24 hours and increases reaction kinetics, as compared to other voltage ranges. However, it may not increase the final purity of the graphitic material.

In an embodiment, the current is constant in the process. In other embodiment, the current is varied in the process. In certain embodiments, the current may be increased to increase the rate of reaction in the process.

In an embodiment, the period is between about 30 minutes and about 2 weeks. In another embodiment, the period is between about 2 h and about 96 h. Preferably, the period is between about 24 h and about 48 h.

In an embodiment, the temperature range is between about 5° C. and about 100° C. In an embodiment, the temperature range is between about 20° C. and about 80° C. In an embodiment, the temperature range is between about 40° C. and about 60° C.

In an embodiment, the anode comprises one or more structures. Preferably, the structures comprise rods, plates, filaments and the like. In an embodiment, the structures are crystalline or non-crystalline. In an embodiment, the structures are graphitic. In an embodiment, the structures comprise platinum or are titanium coated with platinum, preferably are platinum. In an embodiment, the anode comprises graphite, lead, lead alloys, platinum, titanium coated with platinum and combinations thereof. In a particularly preferred embodiment, the structures are titanium coated with platinum.

In an embodiment, the cathode comprises graphite, lead, lead alloys, platinum, titanium coated with platinum and combinations thereof. In an embodiment, the cathode comprises platinum, titanium coated with platinum and graphitic electrodes, various grades of stainless steel, ferrous alloys, other transition metal alloys and the like. In a preferred embodiment, the cathode comprises titanium coated with platinum.

In an embodiment, the process further comprises the use of a permeable membrane covering at least a portion of the anode, cathode, or both. Preferably, the permeable membrane is a neutrally-charged permeable membrane, an anion exchange membrane, or a cation exchange membrane. More preferably, the permeable membrane is selected from asbestos cloth, cellulose, glass cloth, filter cloth, glass cloth impregnated with silica gel, porous sintered stainless steel, vinyl chloride acrylonitrile, polysulfone, polyethersulfone (PES), polycarbonate, polytetrafluoroethylene, polyethylene terephthalate (PET) and combinations thereof. Alternatively, the membrane may comprise sintered metal and non-metal materials such as ceramics.

In an embodiment, the permeable membrane has a molecular weight cut-off (MWCO) of less than about 1 million Da. Preferably, the permeable membrane has a molecular weight cut-off (MWCO) of between about 10 kDa, and about 0.5 kDa. More preferably, the permeable membrane has a molecular weight cut-off (MWCO) of about 3.5 kDa. In one embodiment, the permeable membrane has an air permeability of between 0.1 and 100 L/min/dm² at 200 Pa. Preferably, the permeable membrane has an air permeability of between 1 and 50 L/min/dm² at 200 Pa. More preferably, the permeable membrane has an air permeability of between 2 and 30 L/min/dm² at 200 Pa.

In an embodiment, the purified graphitic material has a purity of greater than about 95% w/w. Preferably, the purified graphitic material has a purity of greater than about 99% w/w. More preferably, the purified graphitic material has a purity of greater than about 99.5% w/w. Most preferably, the purified graphitic material has a purity of greater than about 99.9% w/w.

In an embodiment, the purified graphitic material is used as the crude graphitic material in the process to provide iterative purification.

According to a second aspect of the present invention there is provided a purified graphitic material, when purified by a process as defined according to the first aspect of the present invention.

The present Inventors have surprisingly found a novel, facile approach for the purification of graphite at relatively low cost. The electrochemical processes employed (an electrolytic cell or electrorefining), due to their simple operation give rise to a surprisingly-efficient relatively low-cost process for the purification of graphite.

In some embodiments, the impurity undergoes a redox reaction during electrochemical treatment which removes a portion of the impurity from the graphite. In some embodiments, the impurity that undergoes a redox reaction during electrochemical treatment forms a salt such as a metal salt. In some embodiments, the impurity that undergoes a redox reaction during electrochemical treatment forms a water-soluble salt. In some embodiments, the impurity which undergoes a redox reaction during electrochemical treatment forms a water-insoluble salt.

In some embodiments, the impurity is iron. The iron can be synthetic (e.g., from Fe₃O₄) or naturally occurring (e.g., from hematite) or elemental iron or iron carbide or the like. In some embodiments, the impurity that undergoes a redox reaction during electrochemical treatment forms a cationic species. In some embodiments, the impurity that undergoes a redox reaction during electrochemical treatment forms an iron cationic species such as Fe³⁺.

In some embodiments, the electrochemical treatment does not substantially affect the morphology of, or damage, the graphite. Advantageously, purification without damaging or affecting the morphology of the treated graphite can increase the yield and value of the purified graphite.

In some embodiments, the process comprises the use of a permeable membrane between a cathode and an anode during electrochemical treatment. The membrane primarily serves to prevent the graphite from contacting the cathode and short-circuiting the electrochemical cell.

In some embodiments, the salt formed by the redox reaction further undergoes a salt metathesis reaction. In certain embodiments, the salt metathesis reaction forms an insoluble salt. In some embodiments, the insoluble salt formed by the salt metathesis reaction is iron hydroxide or an iron complex such as jarosite. Advantageously, the insoluble salt, such as iron hydroxide, can be a valuable by-product formed during the purification process of the present invention. For example, iron hydroxide can be used as a catalyst, such as for the decomposition of methane to form graphite and hydrogen gas, most conveniently via the Hazer® Process. As would be appreciated by a skilled addressee, a variety of insoluble iron species can be used as a catalyst for the Hazer® process, either directly or indirectly.

In some embodiments, the electrolyte is a sulfate salt. In some embodiments, the electrolyte is selected from the group consisting of an ammonium sulfate, iron sulfate, sulfuric acid and combinations thereof. Advantageously, when iron sulfate is used as the electrolyte, elemental iron forms on the cathode during the electrochemical treatment of the impure graphite. The elemental iron can be in the form of dendrites and is formed instead of insoluble iron hydroxide. However, those skilled in the art will understand that cell can be tuned so the depositing metal does not form dendrites and instead forms a uniform metallic coating around the cathode (which may be preferable); dendrites are not generally preferred as they may cause a short circuit. Similarly, elemental iron can be a valuable by-product formed during the purification process of the present invention. For example, iron can also be used as a catalyst, such as for decomposition of methane to form graphite and hydrogen gas, again, most conveniently via the Hazer® Process.

In some embodiments, iron in solution is preferred, or elemental iron is precipitated as an insoluble species instead of depositing the elemental iron onto the cathode.

In some embodiments, the impurity is naturally-derived, for example, natural impurities from geological formations such as mined graphite. In some embodiments, the impurity is synthetically derived, for example the impurity is introduced as a result of synthetically producing the graphite. For example, the process described in WO 2016/000115, as related above. This publication, along with WO 2017/031529 is fully incorporated herein by reference in their respective entireties.

In some embodiments, the purified graphite has a purity of greater than 90% (by weight), preferably greater than 95%, more preferably greater than 98% and yet more preferably greater than 99%. In some embodiments, the purified graphite has a purity greater than about 80, 81, 82, 83, 84, 85, 86, 87, 88, 89, 90, 91, 92, 93, 94, 95, 96, 97, 98 or 99%. In some embodiments, the purified graphite has a purity greater than about 98.1, 98.2, 98.3, 98.4, 98.5, 98.6, 98.7, 98.8, 98.9, 99.0, 99.1, 99.2, 99.3, 99.4, 99.5, 99.6, 99.7, 99.8 or 99.9%. In some embodiments, the purified graphite has a purity greater than about 99.95%.

According to another form, the present invention provides a process for purifying graphite comprising: electrochemically treating a graphite containing an impurity selected from an iron, iron oxide and combinations thereof in the presence of an electrolyte comprising a sulfate salt; thereby removing a portion of the impurity as a result of the electrochemical treatment and providing a purified graphite.

According to a third aspect, the present invention provides a purified graphite comprising an impurity selected from a metal, metal oxide and combinations thereof, wherein the purified graphite has a concentration of impurity less than 20% w/w.

In some embodiments, the purified graphite has a concentration of impurity less than 15% w/w, preferably less than 10%, preferably less than 5%, more preferably less than 3%, more preferably less than 2%, yet more preferably less than 1%. In some embodiments, the purified graphite has a concentration of impurity less than 20%, 19%, 18%, 17%, 16%, 15%, 14%, 13%, 12%, 11%, 10%, 9%, 8%, 7%, 6%, 5%, 4%, 3%, 2% or 1% w/w. In some embodiments, the purified graphite has a concentration of impurity less than 0.9, 0.8, 0.7, 0.6, 0.5, 0.4, 0.3, 0.2, 0.1 or 0.05% w/w.

According to a fourth aspect of the present invention there is provided a negative electrode material comprising a coating on a substrate, the coating comprising: MnO₂ (electrolytic manganese dioxide (EMD)), a carbon conductive additive in the form of purified graphitic material according to the second aspect, and a binder.

In some embodiments, the EMD is one or more of α-, β-, γ-, δ-, or λ-MnO₂.

In some embodiments, the EMD is comprised of substantially α-, β-, γ-, δ-, or λ-MnO₂. In some embodiments, the EMD is γ-MnO₂.

In some embodiments, the EMD, the carbon conductive additive and the binder are mixed together in a weight ratio of 4-9:2:1.

In some embodiments, the EMD, the carbon conductive additive and the binder are mixed together in a weight ratio of 7:0.1-3:1.

In some embodiments, the EMD, the carbon conductive additive and the binder are mixed together in a weight ratio of 7:2:0.1-3.

In some embodiments, the EMD, the carbon conductive additive and the binder are mixed together in a weight ratio of 4-9:0.1-3:0.1-3.

In one embodiment, the EMD, the carbon conductive additive and the binder are mixed together in a weight ratio of 7:2:1

In some embodiments, the binder comprises a fluoropolymer selected from the group consisting of polyvinylidene fluoride (PVDF), polytetrafluoroethylene (PTFE), fluorinated ethylene propylene (FEP), perfluoroalkoxyl polymer (PFA) and polyvinyl fluoride (PVF).

In some embodiments, the binder is selected from the group consisting of carboxymethyl cellulose (CMC), sodium alginate, starch, styrene-butadiene rubber (SBR), xanthan gum, polyvinyl chloride (PVC), polyacrylic acid (PAA), polyvinyl alcohol (PVA), polyethylene glycol (PEG), and polyamide imide (PAI).

In one embodiment, the binder comprises polyvinylidene fluoride (PVDF).

In some embodiments, the substrate comprises a metal foil.

In some embodiments, the metal foil is made of a conductive metal.

In some embodiments, the conductive metal is copper, zinc, aluminium, iron or any mixture thereof.

In some embodiments, the coating at least partially surrounds the substrate.

In some embodiments, the coating surrounds the substrate.

In some embodiments, the coating has a thickness in the range of about 1 micron to about 25 microns.

In some embodiments, the coating has a thickness of about 1, 2, 3, 4, 5, 6, 7, 8, 9, 10, 11, 12, 13, 14, 15, 16, 17, 18, 19, 20, 21, 22, 23, 24 or about 25 microns.

In some embodiments the coating has a thickness in the range of about 5 microns to about 20 microns.

In some embodiments the coating has a thickness in the range of about 7 microns to about 15 microns.

In one embodiment, the coating has a thickness of about 10 microns.

In some embodiments, the negative electrode has an electrical conductivity that falls within a range of about 70 S m⁻¹ to about 100 S m⁻¹.

In some embodiments, the negative electrode has an electrical conductivity of about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or about 100 S m⁻¹.

In some embodiments, the negative electrode has an electrical conductivity that falls within a range of about 80 S m⁻¹ to about 95 S m⁻¹.

In one embodiment, the negative electrode has an electrical conductivity of about 90 S m⁻¹.

According to a fifth aspect of the present invention there is provided a battery comprising:
a positive electrode;
a negative electrode; and
an electrolyte in contact with the positive electrode and the negative electrode,
wherein the negative electrode comprises a coating on a substrate, and wherein the coating comprises MnO₂ (electrolytic manganese dioxide (EMD)), a carbon conductive additive in the form of purified graphitic material according to the second aspect, and a binder.

In some embodiments, the EMD is one or more of α-, β-, γ-, δ-, or λ-MnO₂.

In some embodiments, the EMD is comprised of substantially α-, β-, γ-, δ-, or λ-MnO₂.

In some embodiments, the EMD is γ-MnO₂.

In some embodiments, the EMD, the carbon conductive additive and the binder are mixed together in a weight ratio of 4-9:2:1.

In some embodiments, the EMD, the carbon conductive additive and the binder are mixed together in a weight ratio of 7:0.1-3:1.

In some embodiments, the EMD, the carbon conductive additive and the binder are mixed together in a weight ratio of 7:2:0.1-3.

In some embodiments, the EMD, the carbon conductive additive and the binder are mixed together in a weight ratio of 4-9:0.1-3:0.1-3.

In one embodiment, the EMD, the carbon conductive additive and the binder are mixed together in a weight ratio of 7:2:1

In some embodiments, the binder comprises a fluoropolymer selected from the group consisting of polyvinylidene fluoride (PVDF), polytetrafluoroethylene (PTFE), fluorinated ethylene propylene (FEP), perfluoroalkoxyl polymer (PFA) and polyvinyl fluoride (PVF).

In some embodiments, the binder is selected from the group consisting of carboxymethyl cellulose (CMC), sodium alginate, starch, styrene-butadiene rubber (SBR), xanthan gum, polyvinyl chloride (PVC), polyacrylic acid (PAA), polyvinyl alcohol (PVA), polyethylene glycol (PEG), and polyamide imide (PAI).

In one embodiment, the binder comprises polyvinylidene fluoride (PVDF).

In some embodiments, the substrate comprises a metal foil.

In some embodiments, the metal foil is made of a conductive metal.

In some embodiments, the conductive metal is copper, zinc, aluminium, iron or any mixture thereof.

In some embodiments, the coating at least partially surrounds the substrate.

In some embodiments, the coating surrounds the substrate.

In some embodiments, the coating has a thickness in the range of about 1 micron to about 25 microns.

In some embodiments, the coating has a thickness of about 1, 2, 3, 4, 5, 6, 7, 8, 9, 10, 11, 12, 13, 14, 15, 16, 17, 18, 19, 20, 21, 22, 23, 24 or about 25 microns.

In some embodiments the coating has a thickness in the range of about 5 microns to about 20 microns.

In some embodiments the coating has a thickness in the range of about 7 microns to about 15 microns.

In one embodiment, the coating has a thickness of about 10 microns.

In some embodiments, the negative electrode has an electrical conductivity that falls within a range of about 70 S m⁻¹ to about 100 S m⁻¹.

In some embodiments, the negative electrode has an electrical conductivity of about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or about 100 S m⁻¹.

In some embodiments, the negative electrode has an electrical conductivity that falls within a range of about 80 S m⁻¹ to about 95 S m⁻¹.

In one embodiment, the negative electrode has an electrical conductivity of about 90 S m⁻¹.

In some embodiments, the electrolyte is an aqueous electrolyte.

In some embodiments, the electrolyte is an aqueous electrolyte present in a concentration that falls within the range of about 0.01 M to about 10 M.

In some embodiments, the electrolyte is an aqueous electrolyte present in a concentration of about 0.01, 0.05, 0.1, 0.15, 0.2, 0.25, 0.3, 0.35, 0.4, 0.45, 0.5, 0.55, 0.6, 0.65, 0.7, 0.75, 0.8, 0.95, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5 or about 10 M.

In some embodiments, the electrolyte is an aqueous electrolyte present in a concentration that falls within the range of about 0.01 M to about 5 M.

In some embodiments, the electrolyte is an aqueous electrolyte present in a concentration that falls within the range of about 0.01 M to about 2 M.

In some embodiments, the electrolyte is an aqueous electrolyte selected from the group consisting of a sulfate salt, nitrate salt, chloride salt and combinations thereof.

In some embodiments, the electrolyte is an aqueous electrolyte selected from the group consisting of an ammonium sulfate, sodium sulfate, magnesium sulfate, iron sulfate, copper sulfate, zinc sulfate (ZnSO₄), cadmium nitrate, cobalt nitrate, sodium nitrate, sodium chloride, nickel chloride, potassium chloride, ammonium chloride, calcium chloride, sulfuric acid and combinations thereof.

In some embodiments, the electrolyte is zinc sulfate (ZnSO₄), zinc chloride (ZnCl₂), ammonium chloride (NH₄Cl), and zinc trifluoromethyl sulfonate (Zn(CF₃SO₃)₂) or mixtures thereof.

In some embodiments, the electrolyte is an ionic liquid comprising a cation selected from the group consisting of 1-alkyl-3-methyl-imidazolium, N-alkyl-pyridinium, tetraalkyl-ammonium, tetraalkyl-phosphonium and combinations thereof.

In some embodiments, the alkyl group is selected from the group consisting of C₂-C₁₂ alkyl.

In some embodiments, the ionic liquid comprises a cation selected from the group consisting of 1-ethyl-3-methyl-1H-imidazolium, 1-butyl-3-methyl-1H-imidazolium, 1-butylpyridinium and combinations thereof.

In some embodiments, the electrolyte is ZnSO₄.

In some embodiments, the ZnSO₄ electrolyte is present in a concentration that falls within the range of about 0.01 M to about 10 M.

In one embodiment, the ZnSO₄ electrolyte is present in a concentration of 1.0 M.

In some embodiments, the positive electrode is a zinc metal electrode.

In some embodiments, the negative electrode has a specific discharge capacity that falls within a range of between about 50 mAh g⁻¹ to about 200 mAh g⁻¹, when measured between 1.5 V and 0.7 V under a current density of 0.05 A g⁻¹.

In some embodiments, the negative electrode has a specific discharge capacity that falls within a range of between about 70 mAh g⁻¹ to about 120 mAh g⁻¹, when measured between 1.5 V and 0.7 V under a current density of 0.05 A g⁻¹.

In one embodiment, the negative electrode has a specific discharge capacity of at least about 109 mAh g⁻¹, when measured between 1.5 V and 0.7 V under a current density of 0.05 A g⁻¹.

### Definitions

In describing and defining the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

The terms “graphite” and “graphitic material” are generally considered synonymous for the purposes of the present invention. This definition includes carbon materials that are crystalline (short and long-range crystallinity), and most preferably includes the various morphologies described above in relation to the Applicant's prior publication, WO 2017/031529.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic/s of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “weight %” (or “% w/w”), “ratio” will mean “weight ratio” and “parts” will mean “weight parts”.

The term “substantially” as used herein shall mean comprising more than 50% by weight, where relevant, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

The Hazer Group Limited-owned prior art referred to herein (i.e., WO 2016/000115 and WO 2017/031529) are fully incorporated herein by reference.

Any discussion of the prior art throughout the specification should in no way be considered as an admission that such prior art is widely known or forms part of common general knowledge in the field.

Although exemplary embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

“Alkyl” as a group or part of a group refers to a straight or branched aliphatic hydrocarbon group, preferably a C₁-C₁₂alkyl, more preferably a C₁-C₁₀alkyl, most preferably C₁-C₆ unless otherwise noted. Examples of suitable straight and branched C₁-C₆alkyl substituents include methyl, ethyl, n-propyl, 2-propyl, n-butyl, sec-butyl, t-butyl, hexyl, and the like. The group may be a terminal group or a bridging group.

“Aryl” as a group or part of a group denotes (i) an optionally substituted monocyclic, or fused polycyclic, aromatic carbocycle (ring structure having ring atoms that are all carbon) preferably having from 5 to 12 atoms per ring. Examples of aryl groups include phenyl, naphthyl, and the like; (ii) an optionally substituted partially saturated polycyclic aromatic carbocyclic moiety in which a phenyl and one or more C₅₋₇cycloalkyl and/or C₅₋₇cycloalkenyl group or groups are fused together to form a cyclic structure, such as tetrahydronaphthyl, indenyl or indanyl. The group may be a terminal group or a bridging group. Typically, an aryl group is a C₆-C₁₈ aryl group.

Throughout this specification, unless the context requires otherwise, the term “synthetic”, “synthetically-derived” and the like will be understood to imply that the material has been synthesised through chemical techniques.

Throughout this specification, unless the context requires otherwise, the term “natural”, “naturally-derived” and the like will be understood to imply that the material has not been synthesised through chemical techniques such as being mined from a geological formation. Whilst the term “natural”, “naturally-derived” and the like does include naturally-occurring materials, it should not be understood to exclude materials that have gone through physical beneficiation such as crushing, screening or classification and the like.

### BRIEF DESCRIPTION OF THE DRAWINGS

Selected preferred embodiments of the invention will now be described, by way of example only, with reference to the accompanying drawings in which:

FIG. 1 is a schematic embodiment of an electrochemical cell for the purification of graphite comprising an impurity. In particular, FIG. 1a is a 2D side-view; and FIG. 1b is a 3D schematic showing spaced-apart electrode plates.

FIG. 2 shows an embodiment of the invention in the form of a block diagram for an electrochemical purification plant.

FIG. 3 is a flow sheet for an embodiment representing a configuration of an electrochemical purification plant.

FIG. 4 shows a process flow diagram of an embodiment representing a configuration of an electrochemical purification plant.

FIG. 5a is a photograph of a laboratory-scale electrochemical cell taken during testing; and FIG. 5b is a schematic of the embodiment shown in the photograph of FIG. 5a at 3.5 kDa.

FIG. 6 is a thermogravimetric analysis (TGA) curve of electrochemically-purified graphite after 24 hours of treatment.

FIG. 7 shows photographs of the electrochemical purification of graphite over a period of up to 48 hours and shows the removal of iron from the graphite core in the form of Fe(OH)₃ or an iron complex (e.g., photograph of day 1; 24 h).

FIG. 8 is a thermogravimetric analysis (TGA) curve of electrochemically-purified graphite after 48 hours of treatment.

FIG. 9 shows comparative scanning electron microscopy (SEM) micrographs of crude and purified graphite samples. FIG. 9a shows raw graphite comprising an impurity prior to electrochemical treatment; and FIG. 9b shows electrochemically-purified graphite.

FIG. 10 shows a backscatter SEM micrograph of purified graphite after 48 hours of treatment. The graphite retaining any residual iron core are circled.

FIG. 11 is a photograph of elemental iron dendrite having been formed on the cathode instead of iron oxide when using iron sulfate as the aqueous electrolyte.

FIG. 12a is a schematic of the ECP process for Hazer graphite slurry. The schematic shows the experiment contained 16% v/v Hazer graphite/1 M (NH₄)₂SO₄ slurry in a beaker, mixed with a magnetic stir bar. The dialysis bag contains 1 M (NH₄)₂SO₄ and a carbon cathode. The experiment was conducted over 24 h.

FIG. 12b shows testing of the graphite slurry. Hazer graphite was mixed at 16% v/v with the electrolyte to create a graphite slurry. Pure electrolyte was place in the dialysis bag with the cathode, while the anode placed into the slurry. Images show the process over 24 hours.

FIG. 13 shows the TGA of red sludge collected from ECP purification. The thermal decomposition of the iron by-product in the TGA roughly occurs in four stages. These decompositions are similar to that found in the literature, indicating 1) water loss, 2) dehydroxylation with the consequential loss of OH⁻, 3) loss of ammonia and water 4) loss of sulfate from iron sulfate. The TGA ramp rate was 15° C./min.

FIG. 14 shows the catalytic performance of iron by-product (red sludge) using TGA-EG reactor system with 100% CH₄ flow at 900° C., 1 atm and 8 h run.

FIG. 15 is a TGA comparison of laboratory sample “PFBR-019-FL01” purified with different electrolytes. Each of the electrolyte used was able to purify the pilot plant graphite from around 80% to about 93%, However, it is interesting to note the thermal decomposition of each sample varied, which may be suggestive of a change to the structure of the graphite.

FIG. 16 shows FESEM images of the original graphite materials before ECP process.

FIG. 17 shows FESEM images of the purified graphite materials from FIG. 16.

FIG. 18 shows relative pressure and pore of original sample and purified graphite material. (a) N2 physisorption isotherms, and (b) Pore size distributions of original, study 1b, 3b, 4a, and 6 samples.

FIG. 19 shows XRD patterns of original sample and treated graphite materials: (a) XRD pattern of original (PFBR-26-FL01), (b) the standard patterns of Fe (00-006-0696), C (01-089-8487) and Fe3C (01-089-7271), (c) and (d) The comparison of XRD patterns of samples collected before and after the ECP runs.

FIG. 20 shows scanning electron microscopy (SEM) images of carbon materials used as conductive additives in this study. (a) Super P, (b) Carbon-O, (c) Carbon-T, and (d) Carbon-E.

FIG. 21 shows particle size distribution profiles of carbon materials used as conductive additives in this study: super P, Carbon-O, Carbon-T, and Carbon-E.

FIG. 22 shows (a) N₂ physisorption isotherms, (b) pore size distribution, (c) Raman spectra, and (d) TGA profiles of different carbon materials: Super P, Carbon-O, Carbon-T, and Carbon-E.

FIG. 23 shows derivative thermogravimetry (DT) profiles of different carbon materials: super P, Carbon-O, Carbon-T, and Carbon-E.

FIG. 24 shows electrolyte absorption capabilities of EMD electrodes fabricated using different carbon conductive additives over time.

FIG. 25 shows galvanostatic discharge curves of Zn—C batteries fabricated using different carbon conductive additives under the discharge current density of (a) 1.0 A g⁻¹, (b) 0.5 A g⁻¹, (c) 0.1 A g⁻¹, and (d) 0.05 A g⁻¹. (e) The comparison of the specific capacity of Zn—C batteries under different discharge current densities. The inset shows a magnified plot at the low discharge current density region. (f) Nyquist plots of Zn—C batteries. The inset shows the intercept of the impedance curve with the real axis.

FIG. 26 shows (a) GITT profiles of Zn—C batteries assembled using different carbon additives, (b) the enlargement of one GITT segment at the third test cycle, (c) cell resistances of Zn—C batteries during 30 test cycles of GITT, and (d) OCV plots of Zn—C batteries in long-term stability tests over one month.

FIG. 27 shows galvanostatic discharge curves of Zn—C batteries under 0.1 A g⁻¹ after their long-term stability test.

### DETAILED DESCRIPTION OF A PREFERRED EMBODIMENT

The skilled addressee will understand that the invention comprises the embodiments and features disclosed herein as well as all combinations and/or permutations of the disclosed embodiments and features.

### Process

As noted above, one form of the present invention provides a process for purifying graphitic material, the process comprising electrochemically treating a crude graphitic material comprising an impurity in the form of a metal; using a predetermined electrolyte; over a predetermined period; over a predetermined voltage range; over a predetermined temperature range; using a predetermined anode composition; using a predetermined cathode composition; thereby removing a portion of the impurity as a result of the electrochemical treatment and providing a purified graphitic material.

In another form, the present invention provides a process for purifying graphite comprising: electrochemically treating a graphite containing an impurity selected from an iron, iron oxide and combinations thereof in the presence of an electrolyte comprising a sulfate salt or a mixed composition; thereby removing a portion of the impurity as a result of the electrochemical treatment and providing a purified graphite.

The present Inventors have surprisingly found a novel, facile approach for the purification of graphite at relatively low cost. The electrochemical processes employed (an electrolytic cell or electrorefining), due to their simple operation, give rise to a surprisingly-efficient relatively low-cost process for the purification of graphite.

In some embodiments, the process step/s of the present invention can be repeated. In certain embodiments, the step/s of the process of the present invention can be repeated one, two, three, four, five, six, seven, eight, nine or ten (or more) times.

As would appreciated by a skilled addressee, the impurity can be any applicable metal having dimensions ranging from the nm to m range. Suitable metals can be selected from the group consisting of an alkali metal, alkaline earth metal, transition metal, rare earth element and combinations thereof. In certain embodiments, the metal is selected from gold, aluminium, copper, iron, lead, silver, platinum, tin, cobalt, nickel, zinc, and combinations thereof. In preferred embodiments, the metal is iron. In other embodiments, the metal is selected from titanium, sodium, potassium, magnesium, manganese, calcium, or phosphorus. In other embodiments, the impurity may comprise metalloids such as silicon or non-metals such as sulfur. It will be appreciated that the impurities that can be found in graphite are numerous and include any impurities that can be found in typical iron-bearing ores.

Suitable metal oxides can be selected from the group consisting of an oxide of an alkali metal, alkaline earth metal, transition metal, rare earth element and combinations thereof. In certain embodiments, the metal oxide is aluminium oxide, copper oxide, iron oxide, silver oxide, tin oxide, cobalt oxide, nickel oxide, zinc oxide and combinations thereof. In preferred embodiments, the metal oxide is iron oxide. In other embodiments, the oxide comprises silica.

In some embodiments, the impurity undergoes a redox reaction during electrochemical treatment which removes a portion of the impurity from the graphite. In preferred embodiments, the impurity is oxidised during electrochemical treatment which removes a portion of the impurity from the graphite. In some embodiments, the impurity which undergoes a redox reaction during electrochemical treatment forms a salt such as a metal salt. In some embodiments, the impurity which undergoes a redox reaction during electrochemical treatment forms a water-soluble salt. In some embodiments, the impurity which undergoes a redox reaction during electrochemical treatment forms a water-insoluble salt.

In some embodiments, the impurity that undergoes a redox reaction during electrochemical treatment forms a cationic species. In some embodiments, the cationic species is selected from a gold cation, aluminium cation, copper cation, iron cation, lead cation, silver cation, platinum cation, tin cation, cobalt cation, nickel cation, zinc cation and combinations thereof. In preferred embodiments, the impurity which undergoes a redox reaction during electrochemical treatment forms an iron cationic species such as Fe²⁺ or Fe³⁺.

Without wishing to be bound by theory, it is believed that the anion of the electrolyte in solution (preferably, sulfate) undergoes a redox reaction with the impurity when it is transported to the positive electrode (anode) during electrochemical treatment such that the impurity forms a salt (i.e., a metal salt). The metal salt, which can be soluble in solution (separating into cations and anions) can then diffuse out of the graphite thereby removing the impurity from the graphite. The water-soluble metal salt can then subsequently react via salt metathesis to produce a water-insoluble salt. Subject to the electrolyte used, the elemental metal derived from the impurity can be deposited on the cathode during electrochemical treatment. For example, sulfate ions diffuse into the graphite and form iron sulfate, which then diffuses out as a dissolved salt, or the iron impurity undergoes oxidation from Fe to form Fe³⁺, diffuses out of the graphite encapsulation, and then forms iron sulfate.

For example, if an ammonium sulfate ((NH₄)₂SO₄) is used as the electrolyte, it is believed that the ammonium sulfate in water dissolves according to the equations shown below to give ammonium cations (NH₄⁺) and sulfate anions (SO₄²⁻) in solution. The negative sulfate ion is then electrostatically drawn to the positive electrode (anode, for example, graphite comprising impurity) where the anion penetrates the graphite “core” to access the impurity. In the case of an iron core, the iron is converted via a redox reaction to water-soluble iron(III) sulfate (Fe₂(SO₄)₃).

Iron sulfate can then diffuse to the bulk electrolyte solution and optionally through a permeable membrane (such as a dialysis bag). The NH₄⁺ is drawn towards the negative electrode (anode, such as a graphite rod) to produce ammonium hydroxide (NH₄OH) in the electrolytic solution. The hydrogen ions in solution are drawn toward the cathode where they produce hydrogen gas. The water-soluble iron(III) sulfate can subsequently undergo a salt metathesis reaction with the ammonium hydroxide in solution to produce insoluble iron(III) hydroxide (Fe(OH)₃) in the form of a reddish-brown precipitate. The reactions in this embodiment can be summarised as follows:

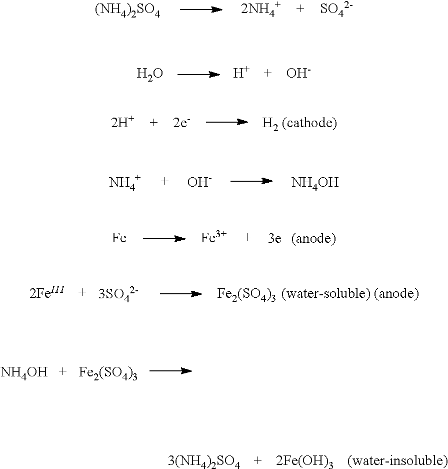

In other embodiments, the iron is precipitated as an iron complex, such as a jarosite, e.g., NH₄[Fe(OH)₂]₃(SO₄)₂.

In some embodiments, the salt formed by the redox reaction further comprises a salt metathesis reaction, for example in the equations above. In certain embodiments, the salt metathesis reaction forms an insoluble salt. In some embodiments, the insoluble salt formed by the salt metathesis reaction is iron hydroxide. Advantageously, the insoluble salt, such as iron hydroxide, can be a valuable by-product formed during the purification process of the present invention. As noted previously, iron hydroxide can be used as a catalyst, such as for decomposition of methane to form graphite and hydrogen gas, for example, via the Hazer® Process.

In some embodiments, the electrochemical treatment does not affect the morphology of the graphite or damage it in any way. Other graphite purification techniques such as using hydrofluoric acid and microwave purification can damage or change the morphology of the graphite after purification. In some embodiments, at least about 70 w/w %, at least about 80 w/w %, at least about 90 w/w %, at least about 95 w/w %, at least about 98 w/w %, at least about 99 w/w % of the purified graphite to total graphite comprising an impurity retains the original morphology prior to the purification process and/or is undamaged.

In some embodiments, the process comprises use of a permeable membrane between the cathode and the anode during the electrochemical treatment. In certain embodiments, the anode is surrounded by a permeable membrane. In preferred embodiments, the cathode is surrounded by a permeable membrane. In certain embodiments, both cathode and anode is surrounded by a permeable membrane.

Alternatively, electrochemical treatment in an undivided cell (that is, without the use of a permeable membrane) can be used to remove an impurity from the graphite. The most significant impediment to the use of an undivided cell may be the propensity to short-circuit given the conductivity of the graphite and/or the electrolyte.

As would be appreciated by a skilled addressee, any suitable type of permeable membrane can be used in the process of the present invention. In some embodiments, the permeable membrane is a neutrally-charged permeable membrane. In some embodiments, the permeable membrane is an anion exchange membrane. In some embodiments, the permeable membrane is a cation exchange membrane.

In some embodiments, the permeable membrane (such as dialysis tubing) has a molecular weight cut-off (MWCO) of less than about 1 million Da, less than about 900,000 Da, less than about 800,000 Da, less than about 700,000 Da, less than about 600,000 Da, less than about 500,000 Da, less than about 400,000 Da, less than about 300,000 Da, less than about 200,000 Da, less than about 100,000 Da, less than about 900 kDa, less than about 800 kDa, less than about 700 kDa, less than about 600 kDa, less than about 500 kDa, less than about 400 kDa, less than about 300 kDa, less than about 200 kDa, less than about 100 kDa, less than about 90 kDa, less than about 80 kDa, less than about 70 kDa, less than about 60 kDa, less than about 50 kDa, less than about 40 kDa, less than about 35 kDa, less than about 30 kDa, less than about 25 kDa, less than about 20 kDa, less than about 15 kDa, less than about 10 kDa, less than about 7.5 kDa, less than about 5 kDa, less than about 4.5 kDa, less than about 4 kDa, less than about 3.5 kDa, less than about 3 kDa, less than about 2.5 kDa, less than about 2 kDa, less than about 1.5 kDa, or less than about 0.5 kDa. In one embodiment, the permeable membrane has an air permeability of between 0.1 and 100 L/min/dm² at 200 Pa. Preferably, the permeable membrane has an air permeability of between 1 and 50 L/min/dm² at 200 Pa. More preferably, the permeable membrane has an air permeability of between 2 and 30 L/min/dm² at 200 Pa.

In some embodiments, the anion exchange membrane comprises positive charges such as a phosphonium cation (i.e., PR₃⁺), sulfonium cation (i.e., SR₂⁺), ammonium cation (NH₃⁺) and the like, where R is independently an H, alkyl, aryl or halide in accordance with the respective definitions provided above.

In some embodiments, the cation exchange membrane comprises negative charges such as phosphate anion (i.e., PO₃⁻), sulfonate anion (i.e., SO₃⁻), carboxylate anion (i.e., COO⁻), C₆H₄O⁻) and the like.

In certain embodiments, the permeable membrane is selected from the group consisting of asbestos cloth, cellulose, glass cloth, filter cloth, glass cloth impregnated with silica gel, porous sintered stainless steel, vinyl chloride acrylonitrile, polyethylene terephthalate (PET), and combinations thereof. In an embodiment, the membrane may be any sintered medium that is not reactive with the electrolyte, such as sintered PTFE.

As will be appreciated by a skilled addressee, any suitable electrolyte can be used in the present invention. In some embodiments, the electrolyte is a sulfate salt, nitrate salt, chloride salt and combinations thereof.

In some embodiments, the electrolyte is selected from the group consisting of an ammonium sulfate, sodium sulfate, magnesium sulfate, iron sulfate, copper sulfate, zinc sulfate (ZnSO₄), zinc chloride (ZnCl₂), zinc trifluoromethyl sulfonate (Zn(CF₃SO₃)₂), cadmium nitrate, cobalt nitrate, sodium nitrate, sodium chloride, nickel chloride, potassium chloride, ammonium chloride (NH₄Cl), calcium chloride, sulfuric acid and combinations thereof. In other embodiments, the electrolyte may be nitric or sulfuric acid.

In preferred embodiments, the electrolyte is selected from the group consisting of an ammonium sulfate, iron sulfate and combinations thereof, for example, ammonium sulfate and sulfuric acid. Advantageously, when iron sulfate is used as the electrolyte in the process of the present invention, elemental iron forms on a cathode during electrochemical treatment of the graphite. The elemental iron is in the form of dendrites and is formed instead of insoluble iron hydroxide. Similarly, elemental iron can be a valuable by-product formed during the purification process of the present invention. For example, iron can also be used as a catalyst, such as for decomposition of methane to form graphite and hydrogen gas, for example via the Hazer® Process as described above.

Based upon preliminary data, the use of iron sulfate as the electrolyte can provide a higher purity graphite compared to use of ammonium sulfate.

In certain embodiments, the electrolyte is an ionic liquid. In certain embodiments, the ionic liquid comprises a cation selected from 1-alkyl-3-methyl-imidazolium, N-alkyl-pyridinium, tetraalkyl-ammonium, tetraalkyl-phosphonium and combinations thereof. In some embodiments, the alkyl group is selected from the group consisting of C₂-C₁₂ alkyl. In some embodiments, the ionic liquid comprises a cation selected from the group consisting of 1-ethyl-3-methyl-1H-imidazolium, 1-butyl-3-methyl-1H-imidazolium, 1-butylpyridinium and combinations thereof.

In certain embodiments, the process of the present invention comprises replacing spent electrolyte, in part or in total, with fresh electrolyte (i.e., new electrolyte that has not been used in the process). In certain embodiments, the part or complete replacement of electrolyte can be via a batch or continuous process.

In certain embodiments, the solution of electrolyte has any suitable pH. In some embodiments, the pH of the solution of electrolyte is between about 1 and 10, between about 6 and 8, between about 8 and 10 and preferably between about 1 and 6, between about 1 and 5 and more preferably between about 1 and 3. In preferred embodiments, the pH of the solution of electrolyte is less than about 6, less than about 5, preferably less than about 3.

In certain embodiments, the solution of electrolyte has a concentration between about 0.01 and 10 M. For example, the solution of electrolyte has a concentration of about 0.01, 0.05, 0.1, 0.15, 0.2, 0.25, 0.3, 0.35, 0.4, 0.45, 0.5, 0.55, 0.6, 0.65, 0.7, 0.75, 0.8, 0.95, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5 or about 10 M.

In some embodiments, the solution of electrolyte preferably has a concentration between about 0.01 and 5 M, between about 0.01 and 3 M, between about 0.01 and 2 M, between about 0.01 and 1 M, between about 0.01 and 0.5 M, between about 0.05 and 1 M, between about 0.05 and 0.5 M, between about 0.05 and 0.3 M and preferably between about 0.05 and 0.15 M. Most preferably, the solution of electrolyte has a concentration of about 0.1 M.

Any suitable solvent can be used in the process of the present invention to dissolve the electrolyte. Typically, the electrolyte is an aqueous solution.

In certain embodiments, the solvent is water, an organic solvent, inorganic non-aqueous solvent, and combinations thereof. In other embodiments, the solvent may be polar. In preferred embodiments, the dispersion medium is selected from the group consisting of water, glycerine, glycerol, cellulose ether, and combinations thereof.

Suitable organic solvents can be selected from the group consisting of pentane, cyclopentane, hexane, cyclohexane, benzene, toluene, 1,4-dioxane, chloroform, diethyl ether, dichloromethane, tetrahydrofuran, ethyl acetate, acetone, dimethyl formamide, acetonitrile, dimethyl sulfoxide, nitromethane, propylene carbonate, n-butanol, isopropanol, n-propanol, ethanol, methanol, formic acid, acetic acid, hexafluoroisopropanol, trifluoroacetic acid and combinations thereof.

Suitable inorganic solvents can be selected from the group consisting of liquid ammonia, liquid sulfur dioxide, sulfuryl chloride, sulfuryl chloride fluoride, phosphoryl chloride, dinitrogen tetroxide, antimony trichloride, bromine pentafluoride, hydrogen fluoride, neat sulfuric acid, hydrochloric acid, nitric acid, phosphoric acid, boric acid, hydrofluoric acid, hydrobromic acid, perchloric acid, hydroiodic acid and combinations thereof.

In certain embodiments, the electrolyte can be dissolved in a mixture of two or more miscible solvents such as a mixture of water and an aqueous soluble solvent or a mixture of an organic and an aqueous soluble solvent.

The process of the present invention can be performed at any suitable temperature. In some embodiments, the process is performed at a temperature of between about 5 to about 200° C., between about 5 to about 100° C., between about 5 to 80° C., between about 5 to 50° C., between about 50 to 100° C., between about 60 to 90° C., between about 70 to 80° C., between about 5 to 30° C. In some embodiments, the process is performed at a temperature less than about 100° C., less than about 80° C., less than about 50° C., preferably less than about 30° C. In preferred embodiments, the process is performed at about 25° C. or between 7° and 80° C. In some embodiments, the process is performed at a temperature of less than about 100, 90, 80, 70, 60, 50, 40, 30, 20 or 10° C.

In some embodiments, the predetermined temperature is between about 5 to about 200° C., between about 5 to about 100° C., between about 5 to 80° C., between about 5 to 50° C., between about 50 to 100° C., between about 60 to 90° C., between about 70 to 80° C., between about 5 to 30° C. In some embodiments, the predetermined temperature is less than about 100° C., less than about 80° C., less than about 50° C., preferably less than about 30° C. In preferred embodiments, the predetermined temperature is about 25° C. or between 7° and 80° C. In some embodiments, the predetermined temperature is less than about 100, 90, 80, 70, 60, 50, 40, 30, 20 or 10° C.

In an embodiment, the cell may be pressurised between about 1 and about 100 bar(g), between about 5 and 90 bar(g), between about 10 and 80 bar(g), between about 15 and 70 bar(g), between about 20 and 60 bar(g), between about 25 and 50 bar(g), between about 30 and 40 bar(g) or around 35 bar(g).

In some embodiments, the impurity is naturally-derived, for example, natural impurities from geological formations such mined graphite. In some embodiments, the impurity is synthetically-derived, for example the impurity is introduced as a result of synthetically producing graphite.

As would be appreciated by a skilled addressee, any suitable graphite comprising an impurity selected from a metal, metal oxide and combinations thereof can be used in the purification process of the present invention. In certain embodiments, the graphite is naturally-derived. In preferred embodiments, graphite is synthetically-derived such that produced via the Hazer® Process referenced above.

As would be understood by a skilled addressee, graphite can exist in many forms, such as: graphitic fibres, which are fibrous carbon structures typically ranging from 100 nm to 100 microns in length such as anisotropic nanofibers (ANF), carbon nano-tubes (CNTs), which are cylindrical nano-structures comprising single or multiple graphitic sheets aligned concentrically or perpendicular to a central axis also fall within the scope of graphitic fibres; carbon nano-onions (CNOs), which are structures that consist of multiple spherical graphitic sheets that are concentrically layered from a central core, which is typically a catalyst particle or a void. These carbon structures typically range from 50-500 nm in diameter; and carbon micro-spheres (CMSs), which can be hollow globular graphitic structures or concentrically layered graphite around a central core, typically greater than 500 nm in size. They are globular in shape and can be chain-like. As noted above, the morphology of the synthetic graphite can be controlled as described in the process of WO 2017/031529.

In certain embodiments, the graphite may have a shape such as flake-like, spherical-like, needle-like, plate-like, wire-like, tube-like, whisker-like, ball-like, nano-graphite, tubes, wires and combinations thereof.

Graphite used in the process of the present invention may have an average size (d₅₀) in the range of between about 10 nm to 350 μm, e.g., of 10 nm to 1 μm, or of 1 μm to 65 μm, or of 100 nm to 10 μm. For example, graphite having an average size of between about 10 nm and 1000 nm may be used, e.g., graphite having an average size of between 10 nm and 100 nm, or between 50 nm and 250 nm, or between 200 and 500 nm, or between 500 and 1000 nm, or between 400 and 750 nm, e.g., of 10 nm, 50 nm, 100 nm, 500 nm or 1000 nm may be used. Graphite having an average size in the range of between about 1 μm to 350 μm may also be used, e.g., graphite having an average size of from 1 μm to 45 μm, or from 40 μm to 60 μm, or from 20 μm to 40 μm, or from 30 μm to 50 μm, or from 40 μm to 50 μm, or from 40 μm to 60 μm, or from 50 μm to 100 μm, or from 100 μm to 250 μm, or from 200 μm to 350 μm, or of less than 300, of less than 200, of less than 100, of less than 65, less than 60, less than 55, less than 50, less than 45, less than 40, less than 35, less than 30, less than 25, less than 20, less than 15, less than 10 or less than 5 μm, or of 350, 300, 250, 200, 150, 100, 85, 65, 60, 55, 50, 45, 40, 35, 30, 25, 20, 15, 10, 5, 4, 3, 2 or 1 μm may be used.

Graphite used in the process of the present invention may have a surface area of between from about 1 to about 1000 m²/g, between from about 1 to 700 m²/g, between from about 1 to about 400 m²/g. For example, the graphite may be a low surface area graphite having a surface area of between 1 and 5, or between 1 and 10, or between 5 and 20, or between 20 and 30, or between 15 and 25, or between 1 and 30 m²/g, e.g., 1, 2, 3, 4, 5, 10, 12.5, 15, 17.5, 20, 22.5, 25, 27.5 or 30 m²/g. Alternatively, the graphite may be a higher surface area graphite having a surface area of between 50 and 400 m²/g, e.g., between 100 and 150, or between 100 and 200, or between 50 and 200, or between 150 and 250, or between 200 and 375, or between 250 and 350, or between 300 and 400, or between 100 and 400 m²/g, e.g., 50, 100, 120, 140, 160, 180, 200, 220, 240, 260, 280, 300, 320, 340, 360, 380, or 400 m²/g. In some embodiments, the graphite has a surface area of less than 300 m²/g, or of less than 200 m²/g, or of less than 100 m²/g. The surface area may be a N₂ (NSA) BET surface area. Nitrogen adsorption measurements at liquid nitrogen temperature may be used to characterise the total surface area of graphite herein based on the Brunauer, Emmett, and Teller (BET) theory of multilayer gas adsorption (see, also, ASTM method D6556-04).

The graphite used herein preferably have a crystallinity of between about 60% to 99.9%. For example, graphite having crystallinities of between 60 and 80%, or between 75 and 90%, or between 85 and 99%, or between 90 and 99%, or between 95 and 99% are preferred, e.g., crystallinities of at least 60%, at least 70%, at least 80%, at least 85%, at least 90%, at least 95%, at least 99% or at least 99.9%, e.g., crystallinities of 60%, 70%, 80%, 85%, 90%, 95%, 99% or 99.9%.

Graphite used in the process of the present invention preferably have a resistivity of about less than about 1.0 Ω·cm, less than about 0.8 Ω·cm, less than about 0.5 Ω·cm, less than about 0.1 Ω·cm, or less than about 0.05 Ω·cm, e.g., a resistivity of between 0.01 and 0.05, or between 0.05 and 0.10, or between 0.05 and 0.15, or between 0.10 and 0.20, or between 0.15 and 0.25, or between 0.25 and 0.4, or between 0.20 and 0.50, or between about 0.4 and 0.65, or between 0.50 and 0.75, or between 0.75 and 1.0, or of between 0.01 and 1 Ω·cm. For example, the graphite may have a resistivity of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 or 1.0 Ω·cm.

In some embodiments, the graphite may be natural graphite, synthetic graphite, amorphous graphite, calcined petroleum coke, crystalline flake graphite, natural flake graphite, surface enhanced flake graphite, expandable graphite, purified flake graphite, purified crystalline flake graphite, purified petroleum coke, purified synthetic graphite, purified-vein graphite, synthetic graphite, primary artificial graphite, secondary artificial graphite, spherical natural graphite, vein graphite and combinations thereof.

The graphite used herein preferably have a carbon content of between about 5% to 99.9%. For example, graphite having a carbon content of between 60 and 80%, or between 75 and 90%, or between 85 and 99%, or between 90 and 99%, or between 95 and 99% are preferred, e.g., carbon content of at least 60%, at least 70%, at least 80%, at least 85%, at least 90%, at least 95%, at least 99% or at least 99.9%, e.g., carbon content of 60%, 70%, 80%, 85%, 90%, 95%, 99% or 99.9%.

In some embodiments, the purified graphite has a purity of greater than about 90%, preferably greater than 95%, more preferably greater than 98% and yet more preferably greater than 99%.

In some embodiments, the purified graphite has a concentration of impurity less than 15% w/w, preferably less than 10%, preferably less than 5%, more preferably less than 3%, more preferably less than 2%, yet more preferably less than 1%.

It should be appreciated that the electrode to be used as an anode or cathode can be made from any suitable conductive material. In some embodiments, the electrode is made from a metal or a metal alloy. In some embodiments, the electrode is made from a material selected from the group consisting of an electroceramic, copper, aluminium, platinum, titanium, gold, silver, iron, steel, stainless steel, brass, bronze, nickel, lead, lead alloy, conductive rubber, conductive carbon such as graphite, graphene and reduced graphene oxide, and combinations thereof. In some embodiments, the electrode can comprise a coating of another conductive material. In other embodiments, the electrodes may be non-metallic electrodes, such as graphite, conducting polymers, conducting ceramics, and other conducting materials that are appropriate for construction of or coating of electrodes (or similar).

It should also be appreciated that the electrode to be used as an anode or cathode can have any suitable thickness. In certain embodiments, the electrode has a thickness of about 1 mm to 30 mm, about 1 mm to about 20 mm, about 5 mm to about 15 mm.

In some embodiments, the process of the present invention uses a plurality of cathodes. In some embodiments, the process comprises use of two, three, four, five, six, seven, eight, nine, ten (or more) cathodes. In some embodiments, the process comprises use of between 2 and 50 cathodes, between 2 and 40 cathodes, between 2 and 30 cathodes, between 2 and 20 cathodes and between 2 and 10 cathodes.

In some embodiments, the process of the present invention uses a plurality of anodes. In some embodiments, the process comprises use of two, three, four, five, six, seven, eight, nine, ten (or more) anodes. In some embodiments, the process comprises use of between 2 and 50 anodes, between 2 and 40 anodes, between 2 and 30 anodes, between 2 and 20 anodes and between 2 and 10 anodes.

As would be appreciated by a skilled addressee, the process of the present invention can be performed using any suitable voltage. In certain embodiments, the process is performed at a voltage of between about 5 and 300 V, about 5 and 240 V, about 5 and 220 V, about 5 and 200 V, about 5 and 150 V, about 5 and 100 V, about 5 and 50 V, about 5 and 30 V, about 5 and 24 V, about 5 and 12 V.

In preferred embodiments, the process of the present invention is performed using direct current. In preferred embodiments, the process of the present invention is performed using alternating current.

In certain embodiments, the process of the present invention can be performed for between about 1 hour and 2 weeks, about 1 hour and 1 week, about 1 hour and 5 days, about 1 hour and 4 days, about 1 hour and 3 days, about 1 hour and 96 hours, about 1 hour and 48 hours, about 6 hours and 48 hours, about 12 hours and 48 hours, about 24 hour and 48 hours.

In some embodiments, the process of the present invention is a batch process. In some embodiments, the process of the invention is a continuous process. In other preferred embodiments, the process of the present invention can be performed on a continuous basis with periodic or constant cycling of the electrolyte, addition of crude graphite and extraction of purified graphite. In some embodiments, crude graphite can be recycled back into the electrochemical cell for further purification.

In certain embodiments, the process of the present invention further comprises a step of washing and/or sonication to remove further impurities. In certain embodiments, the process of the present invention further comprises a filtration step to remove impurities such as using a 0.45 μm filter or centrifugation.

As would be appreciated by a skilled addressee, the process of the present invention can further comprise one or more additional purification step/s. For example, the purified graphite may be further subjected to an acid wash, base wash, heat treatment, or combination thereof, to increase carbon purity beyond that obtained via the inventive process. In some embodiments, graphitic materials pre-treated by a step of acid wash and sonication have a purity of about 96.3%. In certain embodiments, the purity is further increased by another ECP process.

In certain embodiments, process of the present invention comprises a plurality of electrochemical cells. In some embodiments, the process comprises use of two, three, four, five, six, seven, eight, nine, ten (or more) electrochemical cells. In these embodiments, the electrochemical cells can be connected in series or in parallel. Each electrochemical cell comprises at least one cathode and at least one anode.

### Graphite Slurry Solution

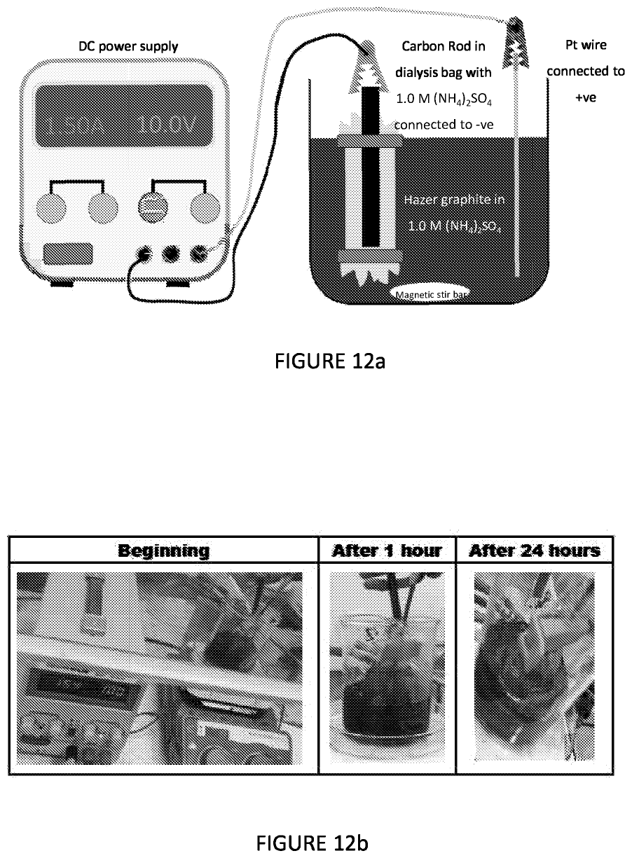

Prior to the present refinement, the inventors' experiments have been conducted by packing graphite into a dialysis bag. However, there are significant difficulties associated with the bulk handling of packed graphite that would be mitigated by the use of a graphite slurry. As such, the viability of using a graphite slurry in the ECP process was explored. The experimental setup was designed in a similar way to the above experiment, but with the contents reversed: 1.0 M (NH₄)₂SO₄ electrolyte and graphite rod (cathode) was placed into a dialysis bag. The Hazer graphite was made into a 16% volume slurry solution with 1.0 M of (NH₄)₂SO₄ electrolyte. The platinum wire was directly inserted into the graphite solution and ECP process operated for 24 h. The setup is depicted in FIG. 12. The slurry experiment revealed several interesting findings, discussed below, thus providing Hazer with several parameters to consider when designing for upscale purification.

FIG. 12b shows the set up for the slurry experiment after 1 hour and after 24 hours. During this process, red sludge could be seen forming within the graphite solution and within the dialysis bag. A noticeable decrease in the current was also observed when conducting ECP of the graphite slurry. This suggests that the resistivity of the graphite slurry was greater than that of packed graphite, due to the inverse relationship of resistivity and current at a constant voltage. This would lower the rate of reaction, necessitating longer reaction times to reach equal levels of purity.

During the ECP process, ionisation of the iron, Fe to Fe³⁺+3e⁻, is vital for the purification. The power required for this reaction can be modelled using the conversion of 1 kg of iron. 1 kg of iron is equivalent to 17.86 moles, with each mole of Fe requiring 3e⁻, equalling 53.57 mol e⁻. Therefore, the power required is:

$$Fe \to {Fe}^{3 +} + 3 {e}^{- 1}$$

$$53.57 moles {e}^{- 1} \times \frac{6.02 \times {10}^{23} eletrons}{1 mole {e}^{- 1}} \times \frac{1.6 \times {10}^{- 19} coulombs}{1 electron} = 5.16 \times {10}^{6} coulombs \times \frac{2.78 \times {10}^{- 4} A . h}{1 coulombs} = 1434 Ah for 1 kg of Fe or 5 kg of Hazer graphite with 80 \% purity$$

Based on these results, tests were conducted to determine other required parameters. Resistivity testing illustrated that the addition of electrolyte in packed graphite vastly reduces the conductivity. The tests were conducted in a three-cell system, with a glass frit separating the two other chambers.

Using the three-cell system, a current test was performed with a multi-meter to investigate the effect of electrode distance. As the electrodes were moved further away, there was a distinct drop in current from 0.3 mA to 0.03 mA.

In the three-cell system the effect of increasing voltage was investigated. By increasing the voltage, while maintaining a set electrode distance, a gradual increase of the current could be observed. By increasing the voltage from 10 V up to 20 V, there was an increase of the current from 0.064 A to 0.145 A. Significantly, this represents a 27% improvement over the current increase expected from the voltage increase, implying the resistance of the system has decreased. The overall current increase provides more power to the cell, and hence increases the rate of reaction.

### Iron By-Product (Red Sludge)

An understanding of the state of the iron is required for the removal of the iron by-products (red sludge) as part of developing and scaling ECP. To do this, iron by-product produced during the ECP process was investigated by two different analysis techniques: TGA and Raman spectroscopy. Both techniques indicated that the iron by-product is more complex than Fe(OH)₃.

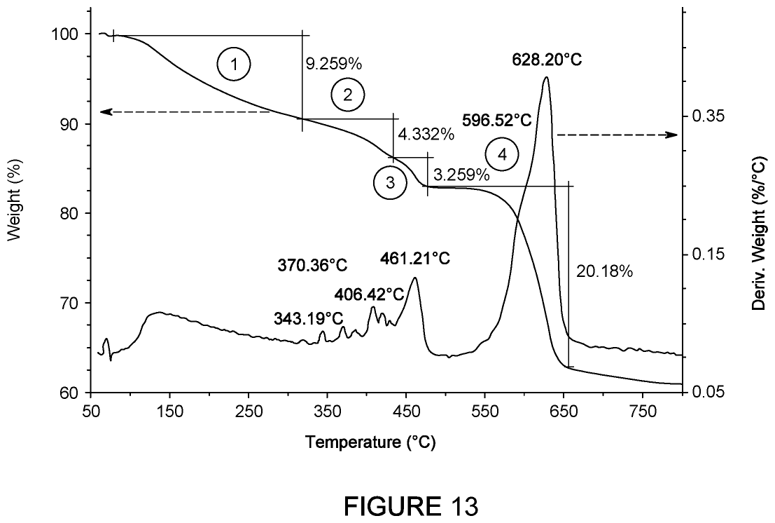

The TGA spectrum in FIG. 13 shows that there are multiple stages of weight loss for the iron sludge, similar to those seen in other research papers investigating ammonium jarosites ((NH₄)Fe₃(SO₄)₂(OH)₆). Described by Frost et al. [Thermal decomposition of ammonium jarosite (NH₄Fe₃(SO₄)₂(OH)₆); J Therm Anal Calorim 84, 489-496 (2006). DOI:10.1007/s10973-005-6953-8], the thermal decomposition stage observed in ammonium jarosite can be observed for the Hazer® graphite TGA spectrum.

Furthermore, Raman spectroscopy of the dried iron sludge (oven-dried at 50° C.; not shown) indicated that the samples consist of a variety of iron oxide species. The observed peaks suggests the presence of Fe₂O₃, Fe₃O₄ and graphite. The presence of Fe₃O₄ has not been previously observed in Hazer® graphites. This may be an unexpected hydrothermal phase transformation at low temperature due to the presence of the iron sulfate, as no SO₄²⁻ peaks (~1005 and 1094 cm⁻¹) were observed.

Results from these tests suggests that the red sludge is an iron complex, possibly ammonia jarosite. Iron oxide could be recovered from jarosite by thermal treatment at >550° C. according to the TGA. Therefore, recovered iron species from the graphite can be used as a high-purity catalyst.

It was observed that most of the red sludge or jarosite will aggregate outside of the dialysis bag, and then settle as sediment. However, it is expected that such aggregation will occur within the dialysis bag too. As such, separation and removal of jarosite from the carbon may be required to obtain high purity graphite. Physical separation via centrifugation was unsuccessful, however loosely attached particles on the surface of the graphite could be removed by vacuum filtration washing to obtain 99.5% purity. A method for removing jarosite, a basic hydrous sulfate material, from graphite would be to solubilise the material in an acid, such as H₂SO₄.

To determine if a H₂SO₄ wash could be an alternative to a time-consuming vacuum filtration wash, 0.1 M of H₂SO₄ was added to the iron sludge, collected from the electrolyte, at a ratio of 1:4. The mixture of H₂SO₄ with the Fe sludge was clearer compared to the control which DI water was added. After 15 h (overnight), the Fe sludge mixed with H₂SO₄ was clear, unlike the control, which the Fe sludge had settled.

This experiment demonstrated that H₂SO₄ can digest the iron-based sludge, resulting in a less vigorous and time-consuming washing procedure. Dependent on the preferred designs for upscaling this technique, this result provides directional information for the downstream cleaning process for the upscaling design. Optimisation the addition of H₂SO₄ to remove excess jarosite, determining the removal rate and concentration required for the removal of the jarosite may better elucidate the present findings.

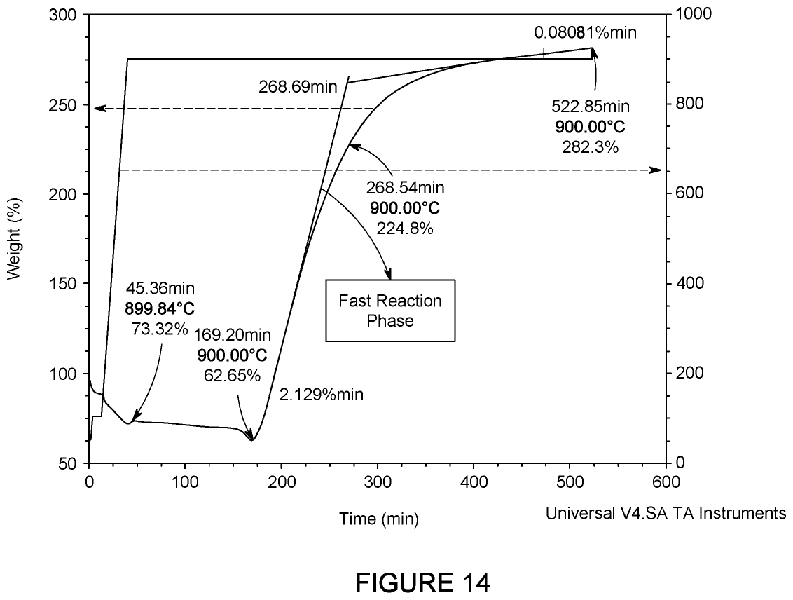

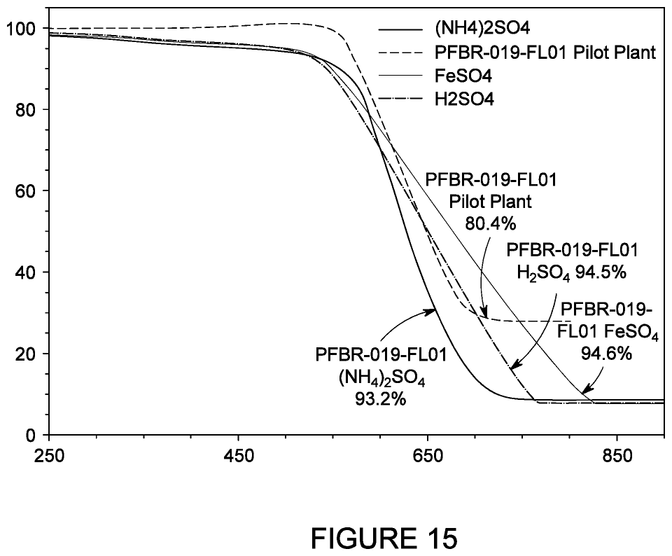

The iron by-product (red sludge) collected from the experiment described above was tested as a potential catalyst for the Hazer® thermal decomposition process. This test was performed using TGA-EG with 100% methane flow at 900° C., 1 atm, and 8 h reaction time (FIG. 14). Then, the performance compared with top two catalysts: Sample XG (synthetic iron oxide) and Sample E (iron ore) which can be seen in Table 2, below.

TABLE 2
Kinetic parameters comparison between
Sample “XG”, Sample “E” and red sludge

| | | | Reaction |
|---|---|---|---|
| | | | rate |
| | | Average | at |
| | Reaction | reaction | fast |
| | time | rate | region |
| Catalyst | (min) | (%/min) | (%/min) |
| Sample XG | 8 | 0.67 | 1.92 |
| Sample E | 37 | 0.62 | 1.71 |
| Iron by- | 125 | 0.62 | 2.12 |
| product | | | |

As shown in Table 2, the full reduction of iron by-product (red sludge) in the Hazer® process is significantly longer than other catalysts. This may be attributable to the complex structure of iron by-product as detailed above. Interestingly, the average reaction rate of iron by-product was the same as Sample E. It is worth noting that the iron by-product tested was collected during purification of a sample initially synthesised from Sample E. This catalyst showed superior catalytic activity in the fast region compared to other two catalysts. It is theorised that it could be related to the catalyst/crystal size, surface area, and very high iron purity in full reduction state of red sludge as the purification process has significantly altered Sample E.

Utilising a different electrolyte in the described ECP process may improve the efficiency of the reaction kinetics. The choice of electrolyte is dependent on the ability of the electrolyte to react with iron and form iron sulfates or other iron soluble structures during the ECP process, as well as ease of removal from the purified graphite. Sulfuric acid is commonly used as an electrolyte due to its high conductivity and the ability to provide a large proton density during the electrochemical reaction improving the reaction rate. To determine the efficiency of H₂SO₄ as an electrolyte for ECP process, an experiment was conducted as described above. However, the electrolyte was replaced with 0.1 M H₂SO₄.

Initial observations included a high production of gas bubbles, possibly from the production of H₂ and O₂ from the electrochemical reaction.

Iron (II) sulfate was the second candidate for testing. FeSO₄ has many advantages, such as the by-product production of elemental iron (Fe), which can be reused as catalyst and the side reactions are relatively simple; the electrolyte used was 0.1 M FeSO₄. The experiment was conducted for over 24 h:

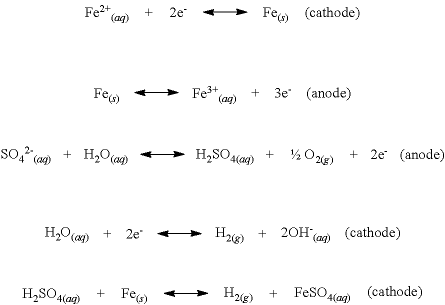

The FeSO₄ electrolyte was initially a cloudy yellow, however after 1 h of ECP the solution became a clear yellow. Small grey particulates could be observed at the bottom of the beaker and dendrites growth were observed on the carbon rod. After 3 h the electrolyte became clear, and more dendrite growth could be observed on the surface of the carbon rod cathode. These dendrites were likely Fe which could be collected and reused as catalyst, optionally in the Hazer® Process.

When comparing the TGA results of the different electrolytes, the efficiency for each was very similar. All the electrolytes were able to purify the graphite from 80% to above 93% in 24 h. The variance between final purity of the graphite was small enough to be considered within experimental error. The efficacy of the purification is therefore not affected by the choice of the electrolyte. Instead, when considering electrolytes, commercial viability, including the ability to recover catalyst, increase reaction rate and/or cost of electrolytes appears paramount. This will require proper technoeconomic analysis to determine the preferred electrolyte.

### Purified Graphite

In another form, the present invention provides a purified graphite comprising an impurity selected from a metal, metal oxide and combinations thereof, wherein the purified graphite has a concentration of impurity less than 20% w/w.

In some embodiments, the purified graphite has a concentration of impurity less than 15% w/w, preferably less than 10%, preferably less than 5%, more preferably less than 3%, more preferably less than 2%, more preferably less than 1%, more preferably less than 0.1% and most preferably less than 0.05% w/w.

In some embodiments, the purified graphite has a purity of greater than about 90%, preferably greater than 95%, more preferably greater than 98% and yet more preferably greater than 99%.

In some embodiments, the purified graphite has a carbon purity of greater than about 90%, preferably greater than 95%, more preferably greater than 98% and yet more preferably greater than 99%.

In certain embodiments, the purified graphite may have a shape such as flake-like, spherical-like, needle-like, plate-like, wire-like, tube-like, whisker-like, ball-like, nano-graphite, tubes, wires and combinations thereof.

In some embodiments, the purified graphite of the present invention may have an average size (d₅₀) in the range of between about 10 nm to 350 μm, e.g., of 10 nm to 1 μm, or of 1 μm to 65 μm, or of 100 nm to 10 μm. For example, purified graphite of the present invention having an average size of between about 10 nm and 1000 nm, e.g., purified graphite having an average size of between 10 nm and 100 nm, or between 50 nm and 250 nm, or between 200 and 500 nm, or between 500 and 1000 nm, or between 400 and 750 nm, e.g., of 10 nm, 50 nm, 100 nm, 500 nm or 1000 nm. Purified graphite of the present invention having an average size in the range of between about 1 μm to 350 μm, e.g., purified graphite having an average size of from 1 μm to 45 μm, or from 40 μm to 60 μm, or from 20 μm to 40 μm, or from 30 μm to 50 μm, or from 40 μm to 50 μm, or from 40 μm to 60 μm, or from 50 μm to 100 μm, or from 100 μm to 250 μm, or from 200 μm to 350 μm, or of less than 300, of less than 200, of less than 100, of less than 65, less than 60, less than 55, less than 50, less than 45, less than 40, less than 35, less than 30, less than 25, less than 20, less than 15, less than 10 or less than 5 μm, or of 350, 300, 250, 200, 150, 100, 85, 65, 60, 55, 50, 45, 40, 35, 30, 25, 20, 15, 10, 5, 4, 3, 2 or 1 μm.

Purified graphite of the present invention may have a surface area of between from about 1 to about 1000 m²/g, between from about 1 to 700 m²/g, between from about 1 to 400 m²/g. For example, the purified graphite may be a low surface area graphite having a surface area of between 1 and 5, or between 1 and 10, or between 5 and 20, or between 20 and 30, or between 15 and 25, or between 1 and 30 m²/g, e.g., 1, 2, 3, 4, 5, 10, 12.5, 15, 17.5, 20, 22.5, 25, 27.5 or 30 m²/g. Alternatively, the purified graphite may be a higher surface area graphite having a surface area of between 50 and 400 m²/g, e.g., between 100 and 150, or between 100 and 200, or between 50 and 200, or between 150 and 250, or between 200 and 375, or between 250 and 350, or between 300 and 400, or between 100 and 400 m²/g, e.g., 50, 100, 120, 140, 160, 180, 200, 220, 240, 260, 280, 300, 320, 340, 360, 380, or 400 m²/g. In some embodiments, the purified graphite has a surface area of less than 300 m²/g, or of less than 200 m²/g, or of less than 100 m²/g. The surface area may be a N₂ (NSA) BET surface area.

The purified graphite of the present invention preferably has a crystallinity of between about 60% to 99.9%. For example, purified graphite having crystallinities of between 60 and 80%, or between 75 and 90%, or between 85 and 99%, or between 90 and 99%, or between 95 and 99% are preferred, e.g., crystallinities of at least 60%, at least 70%, at least 80%, at least 85%, at least 90%, at least 95%, at least 99% or at least 99.9%, e.g., crystallinities of 60%, 70%, 80%, 85%, 90%, 95%, 99% or 99.9%.

Purified graphite of the present invention preferably has a resistivity of about less than about 1.0 Ω·cm, less than about 0.8 Ω·cm, less than about 0.5 Ω·cm, less than about 0.1 Ω·cm, or less than about 0.05 Ω·cm, e.g., a resistivity of between 0.01 and 0.05, or between 0.05 and 0.10, or between 0.05 and 0.15, or between 0.10 and 0.20, or between 0.15 and 0.25, or between 0.25 and 0.4, or between 0.20 and 0.50, or between about 0.4 and 0.65, or between 0.50 and 0.75, or between 0.75 and 1.0, or of between 0.01 and 1 Ω·cm. For example, the purified graphite may have a resistivity of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 or 1.0 Ω·cm.

The purified graphite of the present invention preferably has a carbon content of between about 60% to 99.9%. For example, purified graphite having a carbon content of between 60 and 80%, or between 75 and 90%, or between 85 and 99%, or between 90 and 99%, or between 95 and 99% are preferred, e.g., carbon content of at least 60%, at least 70%, at least 80%, at least 85%, at least 90%, at least 95%, at least 99% or at least 99.9%, e.g., carbon content of 60%, 70%, 80%, 85%, 90%, 95%, 99% 99.9, or 99.95%.

As would be appreciated by a skilled addressee, the purity of the graphite subjected to the inventive process can be determined both before and after treatment using any suitable technique known in the art. For example, suitable techniques to measure carbon purity are thermogravimetric analysis (TGA) or atomic emission spectroscopy (such as inductively coupled plasma atomic emission spectrometry which can also determine the amount of impurity).

### Example 1: Producing Synthetic Graphite Comprising Impurity

An iron oxide is used as a catalyst for the decomposition of methane to produce graphite. Two types of high grade iron oxide were used: hematite (99%, <5 μm, Sigma-Aldrich) and magnetite (95%, <5 μm, Sigma-Aldrich); as well as two iron ore samples: Hematite ore (Pilbara mine) and goethite ore (Yandi mine). The ore samples were milled to <150 μm but otherwise untreated. The “as received” compositional data, particle size distribution, and surface area of all the samples are detailed in Table 3.

TABLE 3
Compositional, particle size and surface area data for the iron oxide samples

| Iron Oxide | | | | | | | | | |
|---|---|---|---|---|---|---|---|---|---|
| Type | Fe % | P % | Si % | Al % | CaO % | MnO % | MgO % | TiO₂ % | |
| Analytical | 69.9 | — | — | — | — | — | — | — | |
| Grade Fe₂O₃ | | | | | | | | | |
| Analytical | 72.3 | — | — | — | — | — | — | — | |
| Grade Fe₃O₄ | | | | | | | | | |
| Hematite ore | 62.9 | 0.1 | 4.0 | 2.2 | 0.0 | 0.1 | 0.0 | 0.1 | |
| (Pilbrara) | | | | | | | | | |
| Goethite ore | 57.9 | 0.0 | 5.5 | 1.4 | 0.0 | 0.0 | 0.0 | 0.1 | continued |
| (Yandi mine) | | | | | | | | | |

| Iron Oxide | | K | | Balance | D₁₀ | D₅₀ | D₉₀ | Surface |
|---|---|---|---|---|---|---|---|---|
| Type | S % | Oxide % | Cl % | Oxide % | um | um | um | area m²/g |
| Analytical | — | — | — | 30.1 | 0.2 | 0.4 | 1.65 | 5.37 |
| Grade Fe₂O₃ | | | | | | | | |
| Analytical | — | — | — | 27.7 | 0.17 | 1.42 | 3.24 | 6.24 |
| Grade Fe₃O₄ | | | | | | | | |
| Hematite ore | 0.0 | 0.0 | 0.0 | 30.5 | 3.2 | 44.5 | 141.0 | 7.62 |
| (Pilbrara) | | | | | | | | |
| Goethite ore | 0.0 | 0.0 | 0.0 | 34.9 | 3.1 | 47.8 | 156.8 | 29.76 |
| (Yandi mine) | | | | | | | | |

Each sample was placed in a separate single stage reactor. The reactors were vertical ½″ (1.27 cm) diameter stainless steel (SS316 Swagelok) tube, with ⅜″ (0.95 cm) quartz tube internal liners. The quartz tube internal liners reduce the catalytic effect of the stainless steel reactor walls by restricting contact with the reacting methane gas. Samples (20 g) of catalyst were contained within a ⅜″ “test-tube like” quartz chamber.

Each sample was reacted at temperatures ranging from 750-950° C., using 10 cm³/min pure methane (UHP), and a reaction pressure between 1-9 bar (absolute). After complete deactivation (approximately 19 h) the reaction was terminated and the samples were cooled with 20 cm³/min of pure nitrogen (UHP). The resulting carbon in the form of graphite (and embedded catalyst particles as the impurity) was weighed to determine the total carbon yield per gram of iron catalyst used.

Low-grade iron ore samples performed almost as well as high-grade oxides for producing graphite, with carbon yields ranging from 9.2 to 8.9 grams of carbon per gram of iron, corresponding to carbon purities of 90 wt % to 89 wt %, respectively.

### Example 2: A Plant for Purification of Graphite

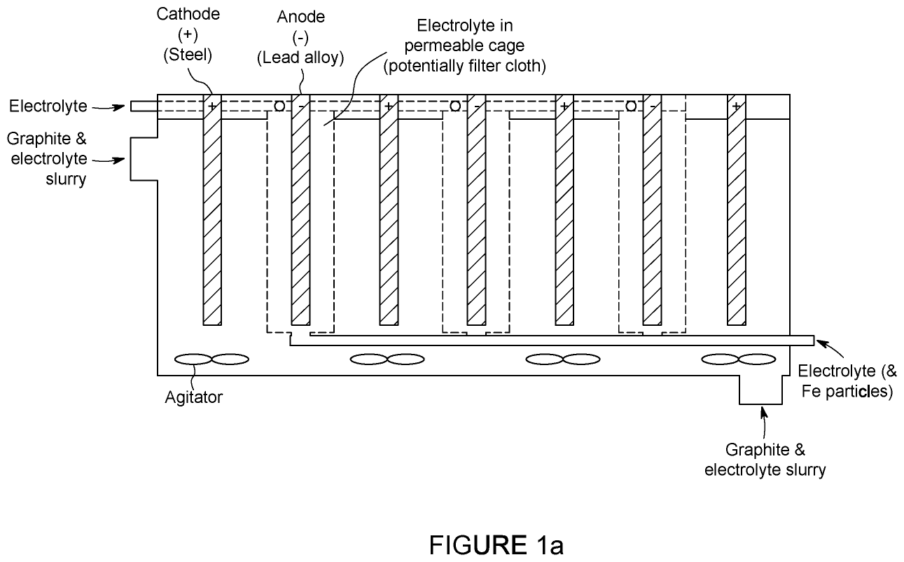

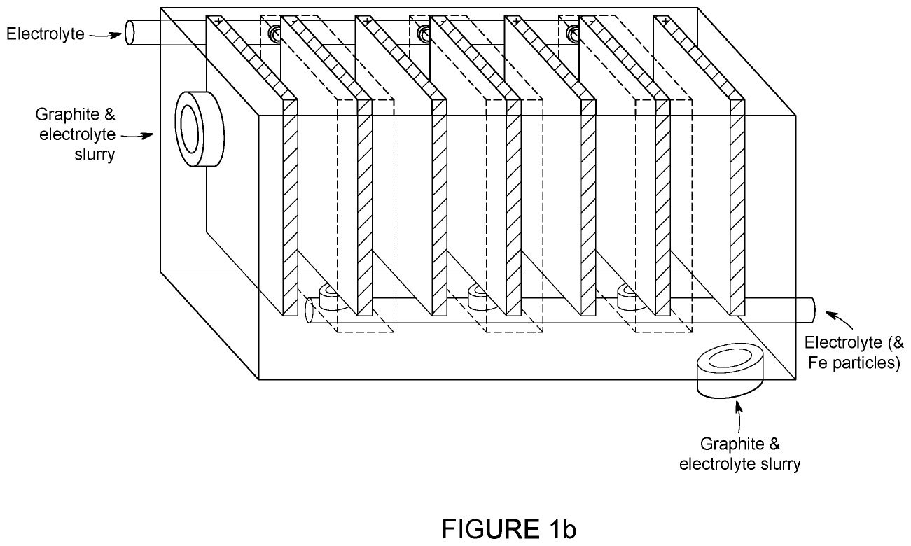

An electrochemical cell, e.g., as shown in FIG. 1, was employed. The cell comprised a permeable membrane (e.g., belt filter cloth) to separate the anodes and cathodes. Constant fresh catholyte (i.e., catholyte that has not been used in the purification process) was pumped through the cathodes constructed of stainless steel. A mixture of fresh anolyte and graphite slurry comprising impurity was pumped through the anodes constructed of lead alloy and the mixture was constantly worked using an agitator. The catholyte and anolyte may be the same or different.

The cathode consisted of three stainless steel plates and the anode consisted of four lead alloy plates. The graphite slurry comprising the impurity was restricted from contacting the cathode via the permeable membrane. The catholyte and anolyte used an iron sulfate solution (0.1 M) and the iron ions formed during electrochemical treatment as a result of the redox reaction was able to permeate the permeable membrane and form insoluble iron hydroxide particles with the elemental iron on the cathode. The cell was fitted with inlet and outlet flow dividers to prevent the formation of “dead” zones over the cathode and anode.

The temperature of the catholyte and anolyte was kept at about 70-80° C. using a water bath. A positive voltage of +10 V was applied to the anode. The purified graphite was then collected as shown in FIG. 1, with the anolyte and the iron particles collected with the catholyte.

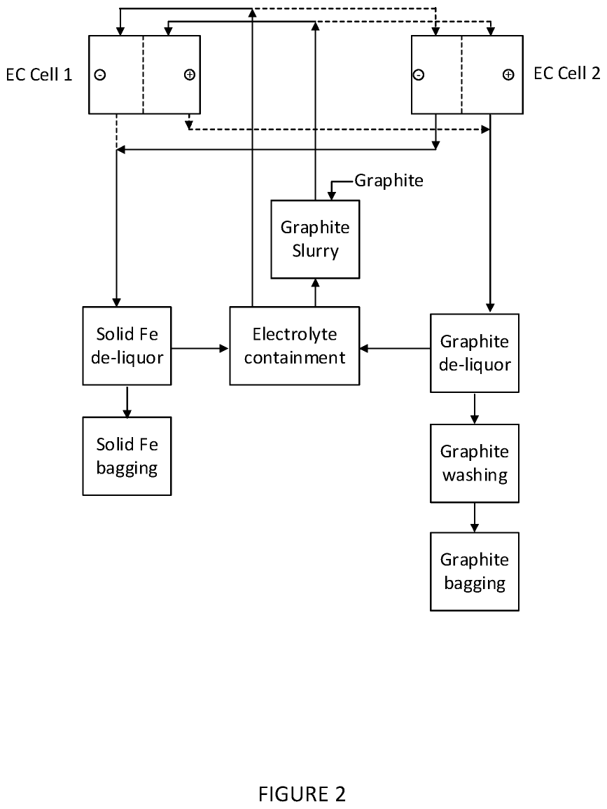

A block diagram is shown in FIG. 2 for an electrochemical purification plant that can handle commercial capacities as required, for example, 1 tonne, 5 tonnes, 10 tonnes, 15 tonnes or 20 tonnes per day of graphite product with a target purity of greater than 99.5 wt %. As above, the graphite was conveyed and treated as a slurry and the system alternated between two electrochemical cells in a batch process. In this system, the filtering equipment was common to both cells. The precipitated or removed iron did not remain on the graphite.

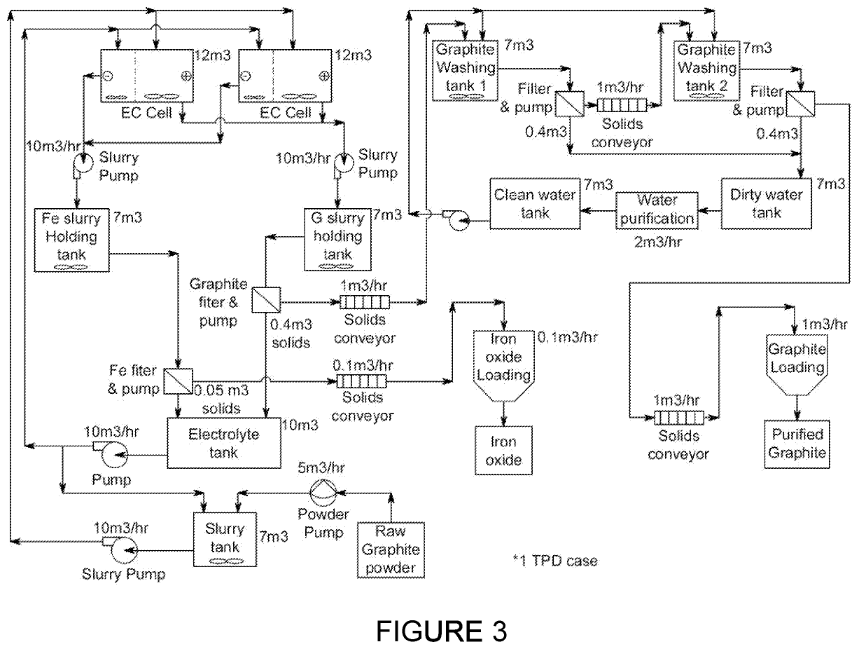

An alternate configuration is shown in FIG. 3, which is a flow sheet for a commercial-scale graphite purification plant. This system is designed to handle, for example, up to 1 tonne per day of graphite product.

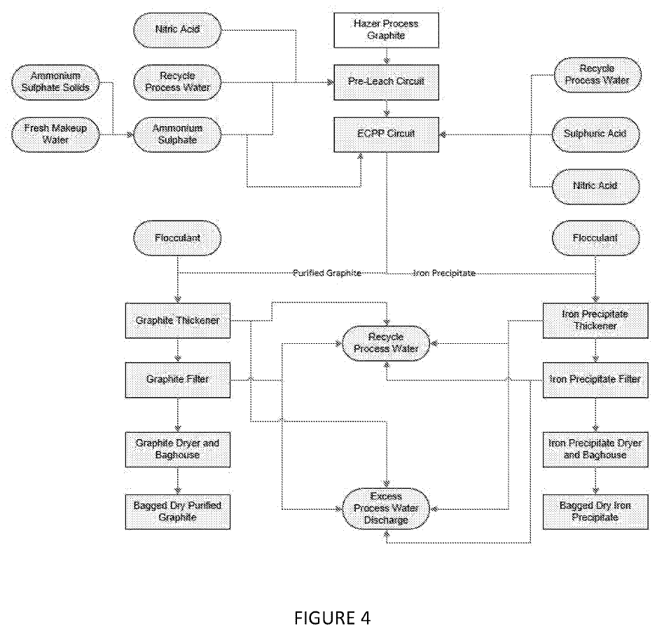

Yet another configuration is shown in FIG. 4. The below provides a description of the primary unit operations for the ECP process (ECPP).

### Reagent Preparation

Ammonium sulphate solids will be discharged from a bulker bag into a 10 m³ agitated mixing tank with fresh Perth Tap Water (PTW) to dissolve the ammonium sulphate.

The 15 m³ ammonium sulphate tank storage tank will be topped up from this mixing tank as required and will top up the Reagent Conditioning Tank as required which will then feed the Pre-Leach Tank 1 at the required ammonium sulphate dose rate.

### Graphite Feed and Pre-Leach Unit Operations

Graphite is expected to be conveyed from the Hazer Process into a 10 m³ hopper which contains a 20 mm×20 mm safety/trash screen inside the hopper designed to remove any rubbish which may potentially carry over from the Hazer Process. The 10 m³ hopper is lidded to minimise ingress of moisture and contaminants.

Graphite will then be screw fed into a feed vortex mixer which is designed to adequately wet the graphite prior to reporting to the first Pre-Leach tank using recycle process water.

Ammonium sulphate solution will be fed through an inline solution heater from the 15 m³ ammonium sulphate tank to increase the temperature to approximately 70° C. prior to being dosed into Pre-Leach Tank 1. During Pre-Leach circuit testwork heat was required to be added into the circuit to maintain the slurry at the target temperature with insufficient heat coming from the acid addition reaction.

Nitric acid will also be dosed into Pre-Leach Tank 1 at the required flowrate. Nitric acid is required to prevent the graphite from frothing. Graphite frothing resulted in significant material handling issues and it has been concluded that without nitric acid addition, graphite slurry will not effectively flow through the Pre-Leach tanks.

Slurry will flow from Pre-Leach Tank 1 to 3 via gravity before being pumped into the ECPP circuit. The temperature in the Pre-Leach circuit will be maintained by immersion heaters (designed with titanium to withstand the acidic environment, set at a setpoint of 70° C.). Each pre-leach tank will be agitated utilising an overhead agitator to maintain a homogenous suspended slurry.

Each tank will be lidded and vented to the top of the building to remove fumes generated from the process.

### ECPP Cell Operations

Each ECPP cell contains a single anode in the central section which is separated by filter cloth which acts as a membrane allowing only solution and ions to pass between the inner and two outer sections. Each outer section contains a cathode. The central anode section slurry will be suspended by two overhead agitators (one on each side of the anode) to maintain a homogenous slurry within this section. A positive charge will be applied to central anode section whilst a negative charge is applied to each of the cathodes. Each cell will be lidded and vented to the top of the building to remove fumes generated from the process.

Slurry from the Pre-Leach circuit will discharge into the central anode section of ECPP Cell 1 with liquor containing precipitated iron (iron slurry) from ECPP Cell 2 being fed into both of the ECPP Cell 1 outer sections. Sulphuric acid will also be pumped into the ECPP Cell 1 anode section at a controlled rate.

ECPP Cell 1 cathode iron slurry will be pumped to the Iron Precipitate Thickener whilst the inner anode section slurry will be pumped at a controlled rate (the same as the Pre-Leach discharge rate) to ECPP Cell 2.

Anode section slurry will be pumped to the succeeding ECPP cell again at a controlled rate until it is pumped from ECPP Cell 4 into the Graphite Thickener. The aim of pumping the anode section slurry to the back of the circuit is to reduce the iron concentration and subsequently iron washing requirements in the downstream Graphite Filter.

Ammonium sulphate solution, sulphuric acid and nitric acid will be dosed into the Recycle Conditioning Tank along with recycle process water. Recycle process water will be pumped into both of the ECPP Cell 4 cathode sections whilst it's expected the vast majority of the iron that's dissolved in solution will precipitate as iron ammonium sulphate due to the pH rising in the cathode section. ECPP testwork resulted in the outer cathode section pH rising due to hydrogen evolution at the cathode which subsequently resulted in the iron precipitating. Each cathode section iron slurry will be pumped to the preceding ECPP cathode sections until as previously described, it will be discharged to the Iron Precipitate Thickener.

### Graphite Thickener

ECPP Cell 4 anode discharge slurry will feed the Graphite Thickener. The Graphite Thickener will be dosed with a pre-determined amount of flocculent to settle the graphite slurry and generate a slurry with increased solids content which will be pumped from the base of the thickener as a thickened slurry (underflow) to the Graphite Filter. The thickener overflow which will contain a low total suspended solids concentration liquor will be discharged into the process liquor Catchment Tank.

### Graphite Filter

The Graphite Thickener underflow will be pumped into an agitated surge tank prior to being pumped into a plate and frame vacuum filter where it will be filtered into a cake. Upon being filtered, it will be washed with a 5% sulphuric acid solution to remove any dissolved iron which is inherent in the liquor contained within the filter cake. It will then be washed with PTW to increase the pH of the liquor within the cake and removed any inherent sulphuric acid. The initial filtrate along with both wash solutions will report to the catchment tank for recycle with the majority to be recycled within the Hazer ECPP Circuit.

Washed filter cake will be discharged into a hopper prior to being screw fed into the Graphite Flash Dryer.

### Graphite Flash Dryer and Bag House

Graphite will be fed into the Graphite Flash Dryer to generate a dry product that will be discharged into a bag house which will load the dried graphite into 1 m3 bulker bags which will then be transported into the baghouse storage zone.

### Iron Precipitate Thickener

ECPP Cell 1 anode discharge iron slurry will feed the Iron Precipitate Thickener. The Iron Precipitate will be dosed with a pre-determined amount of flocculent to settle the iron slurry and generate a slurry with increased solids content which will be pumped from the base of the thickener as a thickened slurry (underflow) to the Iron Precipitate Filter. The thickener overflow which will contain a low total suspended solids concentration liquor will be discharged into the process liquor Catchment Tank.

### Iron Precipitate Filter

The Iron Precipitate Thickener underflow will be pumped into an agitated surge tank prior to being pumped into a plate and frame vacuum filter where it will be filtered into a cake. The filtrate will report to the catchment tank for recycle with the majority to be recycled within the Hazer ECPP Circuit.

Filter cake will be discharged into a hopper prior to being screw fed into a flash dryer.

### Iron Precipitate Flash Dryer and Bag House

Iron precipitate filter cake will be fed into the flash dryer to generate a dry product that will be discharged into a bag house which will load the dried iron precipitate into 1 m3 bulker bags which will then be transported into the baghouse storage zone.

### Example 3: Determination of Carbon Purity by Thermogravimetric Analysis

The carbon purity was determined using thermogravimetric analysis (TGA) of the purified graphite powder. The TGA analysis of purified graphite was performed in two steps. The first step raised the temperature to 100° C. and was maintained for 15 min to remove moisture and was followed by ramping the temperature to 900° C. in air to burn off any carbon. Weight loss occurred in two stages: removal of a functional group followed by weight loss due to carbon burn-off. The relative weight of material remaining (corresponding to impurity) allows for determination of the carbon purity.

### Example 4: Electrochemical Purification of Graphite

Graphite (5.0 g) comprising impurity (for example, as produced in Example 1) was compacted in a dialysis bag (3.5 kDa MWCO) and a platinum wire was inserted which acted as a current collector. The dialysis bag was sealed at both ends with plastic clips. The graphite in the dialysis bag was used as working electrode (anode) and a graphite rod was used as the counter electrode (cathode).

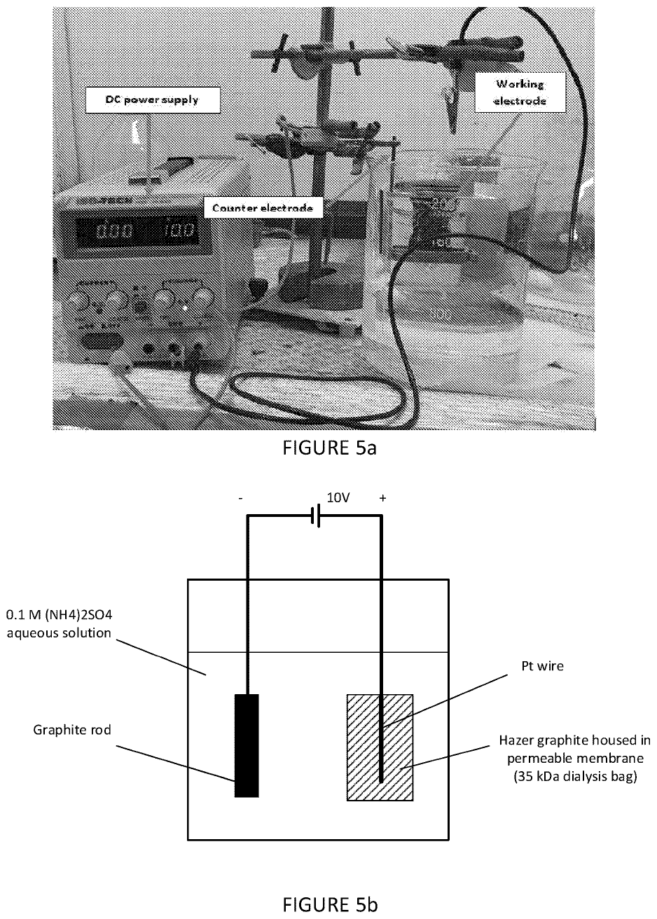

The working electrode and the counter electrode were immersed in 2 L of 0.1 M (NH₄)₂SO₄ aqueous solution. A positive voltage (+10 V DC) was applied to the working electrode for 24 hours. A photograph of the electrochemical setup is shown in FIG. 5a and a schematic version of the setup is shown in FIG. 5b.

Graphite comprising impurity, having an initial purity of 80.4%, was used. The electrochemically purified graphite was washed and centrifuged with deionised water multiple times (at least three times) to remove any residual salt from the electrolytic solution. The subsequently dried powder was used for characterisation.

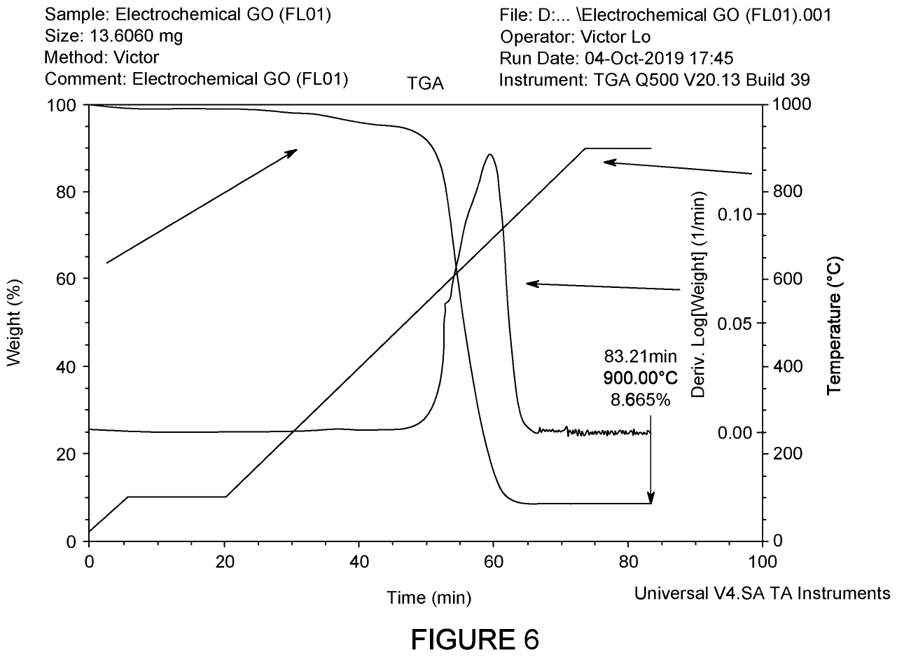

The carbon purity of the purified graphite was determined using thermogravimetric (TGA) analysis. The weight loss curve shown in FIG. 6 shows about 2% weight loss attributed to the moisture content of the electrochemical graphite powder. There was no substantial weight loss until the temperature reached about 500° C., which is likely to be an indication of the minute degree of functionalisation during the electrochemical process. The rapid weight loss at around 600° C. is attributed to the carbon burn-off and the remaining weight was the residual iron in oxide form. The carbon purity of the electrochemical treatment of this batch was calculated to be 93.2% (by weight) after 24 hours of electrochemical treatment.

As discussed above, the TGA analysis before and after the electrochemical treatment indicates the increase in carbon purity from 80.4% (by weight) for raw graphite comprising impurity to 93.2% for purified graphite after 24 hours of electrochemical treatment.

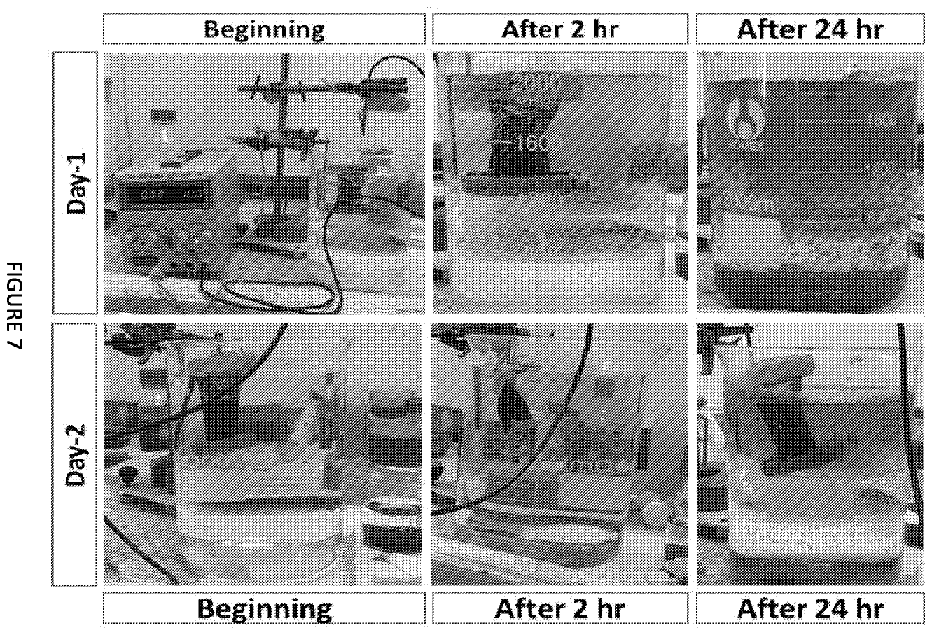

A further batch of electrochemical treatment was also performed over a 48-hour period. In this batch, the electrolyte was changed every 24 hours. The electrochemical treatment of the graphite comprising impurity over a 48-hour period is shown in FIG. 7. As shown in the photograph “Day 1; Beginning”, the beaker originally contained a clear solution of (NH₄)₂SO₄, which turns yellowish in colour after two hours (“Day 1; After 2 hr”).

At the end of the first day (Day 1; After 24 hr”), the reaction bath comprising electrolyte was saturated with red/orange sludge that started to agglomerate and precipitate at the bottom of the beaker. A similar observation was observed during day 2 and the reaction bath again started to produce red sludge that agglomerates.

As rationalised above in respect of the electrochemical reactions for an aqueous solution of ammonium sulfate, the Inventors believe that the water-soluble iron(III) sulfate reacts with the ammonium hydroxide in solution to produce insoluble iron(III) hydroxide (Fe(OH)₃) which is a reddish-brown precipitate.

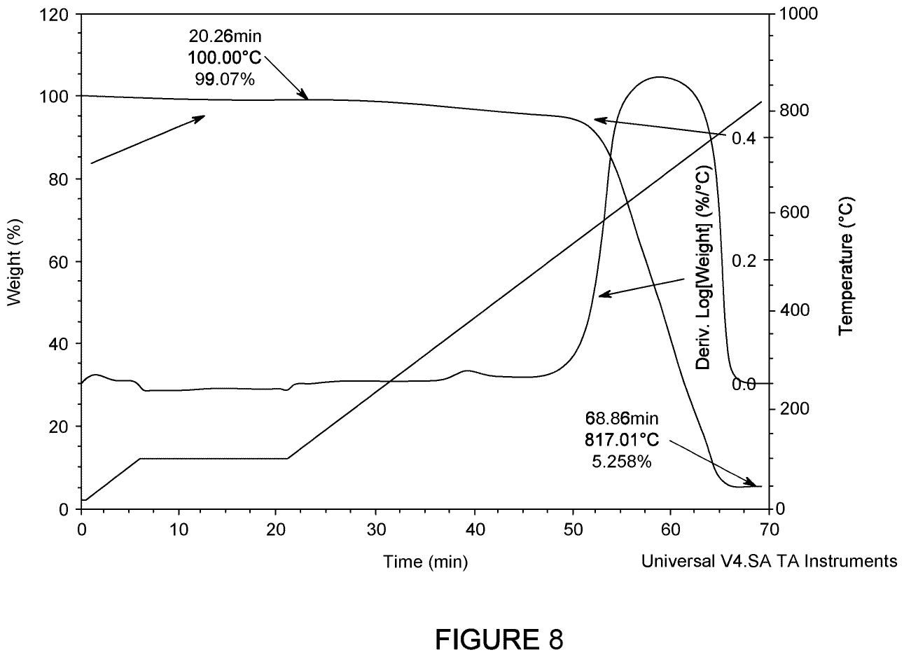

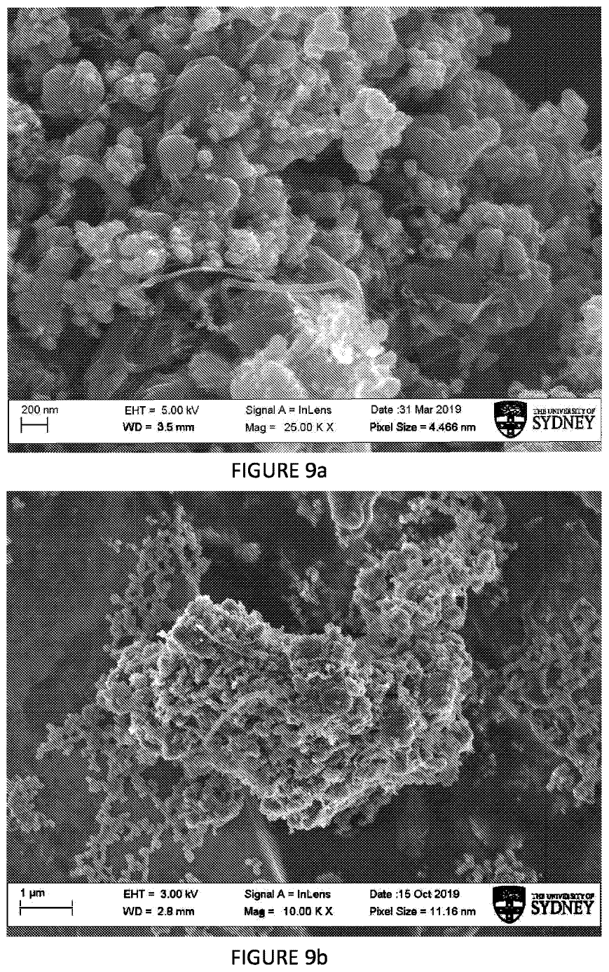

The graphite was analysed by TGA after 48 hours of electrochemical treatment to determine the graphite purity and the result is shown in FIG. 8. The graphite purity went from 80.2% in raw graphite comprising impurity to 93.2% after day 1 (FIG. 6) and then 96% after day 2 (FIG. 8) which indicates the effectiveness of the process of the present invention to purify graphite.

Surprisingly, the Inventors also found that the graphite structure or morphology was not affected by process of the present invention. The SEM micrograph of the graphite before and after the electrochemical treatment is shown in FIGS. 8a and 8b, respectively, where intact CNO and ANF structures can be seen after treatment.

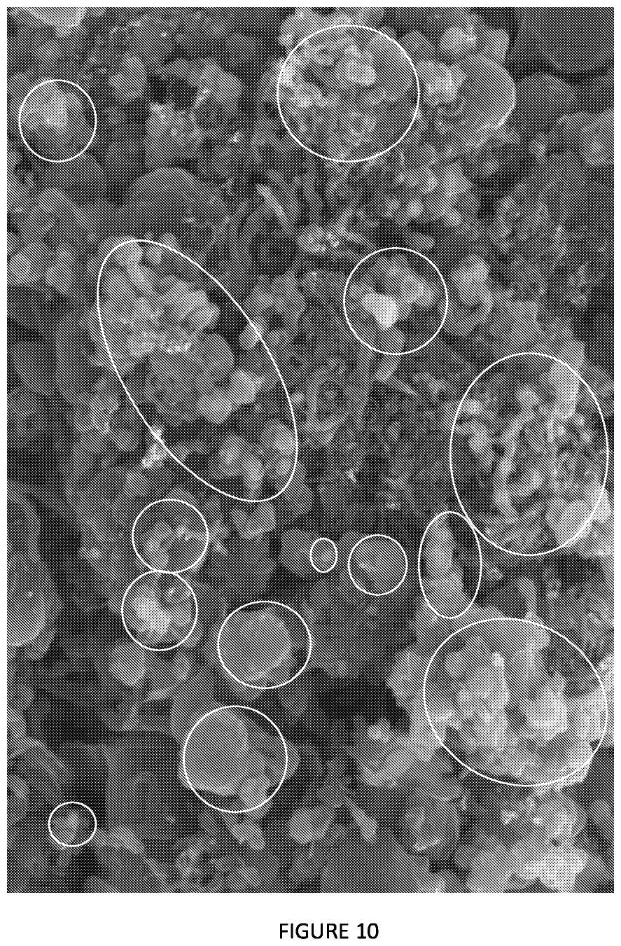

A backscattered SEM micrograph was also performed on the graphite after treatment to examine the iron removal from the graphite core; the results are shown in FIG. 10. The image reveals many CMS and CNO morphological regions without any iron core, whereas some CNO still has residual iron (circled). Even after 48 hours of electrochemical treatment, most of the purified graphite structures remain undamaged, which was an unexpected result.

In another test batch, the purified graphite was found to have a purity of 99.6% after electrochemical treatment for 48 hours from an initial graphite purity of 90.2%.

In a further test batch, the purified graphite was found to have a purity of 99.5% after electrochemical treatment for 96 hours, based on an initial graphite purity of 85%, wherein the impurity was iron.

Further experimental data are shown in Table 4, below.

TABLE 4
Purity of purified graphite after electrochemical treatment

| | TGA | Carbon |
|---|---|---|
| | remaining | purity |
| Treatment | (%) | (%) |
| Raw graphite comprising impurity | 21.69 | 85.09 |
| 48 hours of electrochemical | 1.603 | 98.88 |
| purification | | |
| 48 hours of electrochemical purified | 1.486 | 98.96 |
| followed by 3 centrifuge washes | | |
| with deionised water | | |
| 96 hours of electrochemical | 1.005 | 99.30 |
| purification | | |
| 96 hours of electrochemical purified | 1.006 | 99.30 |
| followed by 1 centrifuge wash with | | |
| deionised water | | |
| 96 hours of electrochemical purified | 0.74 | 99.48 |
| followed by 1 centrifuge wash with | | |
| deionised water and filtration with a | | |
| 0.45 μm filter. | | |

The results shown in Table 4, above, confirm that graphite purities of 99.5% can be attained using the purification process of the present invention.

### Example 5: Electrochemical Purification Using Alternative Electrolyte

In Example 5, graphite was purified using the process of Example 1, using an aqueous solution of iron sulfate at the electrolyte.

The Inventors surprisingly found that when an aqueous solution of iron sulfate (FeSO₄) was used, the insoluble iron species Fe(OH)₃ does not contaminate the purified graphite and would otherwise affect purity of the graphite (or require costly treatments such as acid digestion after electrochemical treatment).

The Inventors observed increased graphite purity as a result of using an iron sulfate electrolyte. Further, there was no apparent precipitated iron in the graphite.

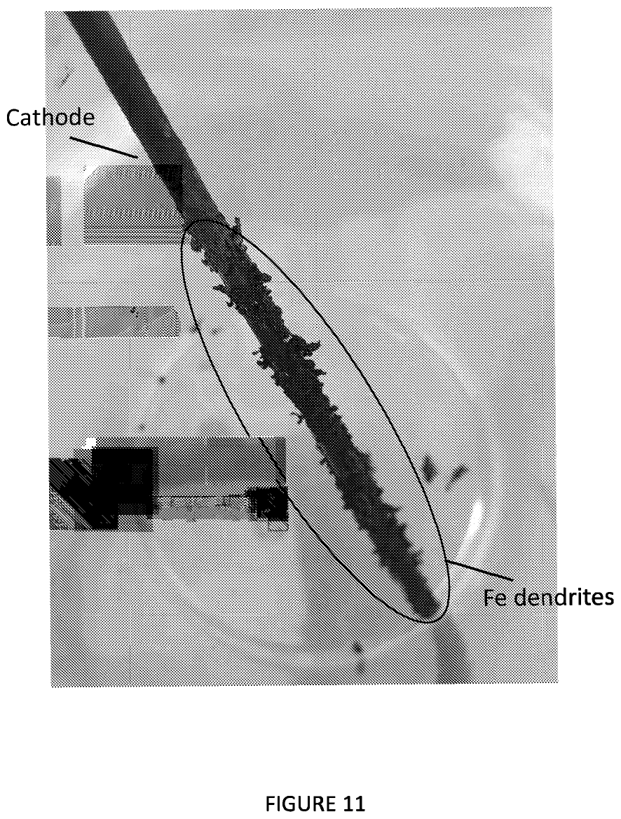

As shown in FIG. 11, the use of iron sulfate as the electrolyte resulted in elemental iron dendrites forming on the cathode, instead of forming iron oxide as may otherwise have been anticipated. Iron dendrites are, in turn, a valuable by-product, and can be used, for example, as catalyst in a process for the formation of graphite, such as the process described in Example 1.

### Example 6: Electrochemical Purification Versus Standard High-Temperature Thermal Treatment

In order to compare the purity of the graphitic material purified via the electrochemical process (ECP) of the present invention, graphitic carbon material produced via the catalytic decomposition of methane (CDM) using Fe ores as catalysts, was purified by a standard high-temperature thermal treatment and the electrochemical process (ECP).

### Material Synthesis

Specifically, the graphitic carbon material was synthesized in a fluidized bed reactor operating with CH₄ at 900° C. and 8 bar(g). Here, the methane decomposes into graphite on the surface of the iron ore catalyst via “dusting” and hydrogen. The term “dusting” is an industry term used to describe a reaction that disintegrates metallic material (often ferrous) into fragments and graphite within a carburizing environment. This effect begins by methane molecules (or other carbonaceous gases) adsorbing and dissociating on the surface of the metal-containing catalyst and the resulting carbon diffusing into the surface of the bulk metal. Once this outer layer is saturated with carbon, it forms metal carbide and then precipitates from the metallic grain boundaries as graphitic carbon. Over time this causes inter-granular pressure that separates the metal carbide particles from the parent bulk metal, and causes the metal structure to disintegrate by ‘dusting’.

In doing so, the catalyst separates and fragments into nano-fragments and become encapsulated in carbon/graphite. The resulting graphitic carbon materials encapsulating Fe particles are hereinafter referred to as “Carbon-O”. According to the standard thermal purification method, Carbon-O was purified in a vacuum furnace at a high-temperature treatment up to 2800° C., removing the encapsulated Fe particles. The resulting material is denoted as “Carbon-T”. For comparison, Carbon-O was also purified in an electrochemical cell (as shown in FIG. 5b) according to the electrochemical process (ECP) of the present invention. Here, the Carbon-O was compressed into carbon rods and subsequently employed in the electrochemical cell as a positive working electrode. A platinum foil served as a negative counter electrode in a 0.1 M ammonium sulfate ((NH₄)₂SO₄) electrolyte, and a DC power of 10 V was applied to the two electrodes. Charged ions in the electrolyte were intercalated among graphene layers of carbon materials in the carbon rod, and encapsulated Fe particles were slowly leached over 20 h. The resulting carbon materials in the carbon rod were collected and denoted as “Carbon-E”.

Apart from the above three types of graphitic carbon materials, a commercial carbon conductive additive (Super P, Thermo Fisher) was used as a reference.

The morphology of the carbon materials was examined by scanning electron microscopy (SEM, Zeiss, Gemini Ultra Plus). The average particle size of carbon materials dispersed in water was analyzed using a particle size analyzer (Malvern Mastersizer 3000). Their surface area and pore structures were characterized by N₂ physisorption using a pore size analyzer (Quantachrome Autosorb iQ). The density functional theory (DFT) method was used to calculate their pore size distribution from their N₂ physisorption isotherms. Their chemical properties were characterized by Raman spectroscopy (Renishaw Raman inVia Reflex) under a 532 nm excitation laser. Their chemical composition was investigated by thermogravimetric analysis (TGA) on a thermogravimetric analyzer (TA Instruments Q500) under an airflow with temperatures increasing from 25 to 900° C. at a ramping rate at 15° C. min⁻¹. The elemental composition of the ashes obtained after TGA was characterized by X-ray fluorescence spectroscopy (XRF) using a wavelength dispersive XRF spectrometer (PANalytical AXIOS, PW2400) fitted with a 4-kW X-ray source.

### Electrode Fabrication and Characterization

Firstly, MnO₂ (electrolytic manganese dioxide—(EMD)) was homogenized in a planetary ball milling (Changsha Tianchuang Power Technology XQM-0.4) at 400 rpm for 5 h.

The EMD is one or more of α-, β-, γ-, δ-, or λ-MnO₂.

In some embodiments, the EMD is comprised of substantially α-, β-, γ-, δ-, or λ-MnO₂.

Good results were obtained when γ-MnO₂ was used as the EMD

Next, γ-MnO₂, carbon conductive additives, and a binder were mixed together in a suitable solvent.

In some embodiments, the binder takes the form of a fluoropolymer binder, which may be selected from the group consisting of polyvinylidene fluoride (PVDF), polytetrafluoroethylene (PTFE), fluorinated ethylene propylene (FEP), perfluoroalkoxyl polymer (PFA) and polyvinyl fluoride (PVF). In other embodiments, the binder may be selected from the group consisting of carboxymethyl cellulose (CMC), sodium alginate, starch, styrene-butadiene rubber (SBR), xanthan gum, polyvinyl chloride (PVC), polyacrylic acid (PAA), polyvinyl alcohol (PVA), polyethylene glycol (PEG), and polyamide imide (PAI).

In some embodiments, the EMD, the carbon conductive additive and the binder are mixed together in a weight ratio of 4-9:2:1, preferably, a weight ratio of 7:0.1-3:1, more preferably, a weight ratio of 4-9:0.1-3:0.1-3.

In one embodiment, the EMD, the carbon conductive additive and the binder are mixed together in a weight ratio of 7:2:1

Good results were obtained using polyvinylidene fluoride (PVDF) as a binder, and where γ-MnO₂, carbon conductive additives and the polyvinylidene fluoride (PVDF) binder were mixed together in N-methyl-2-pyrrolidone (NMP) in a weight ratio of 7:2:1.

The four carbon materials (Super P, Carbon-O, Carbon-T, and Carbon-E) were used as conductive additives separately. The obtained slurry was then cast on a conductive metal foil using the doctor blade method to form at least a partial coating on the conductive metal foil with a thickness in the range of about 1 microns to about 25 microns. For example, the thickness of the coating may fall within the range of about 1, 2, 3, 4, 5, 10, 12.5, 15, 17.5, 20, 22.5, 25, 27.5 or 30 m²/g. about 1, 2, 3, 4, 5, 6, 7, 8, 9, 10, 11, 12, 13, 14, 15, 16, 17, 18, 19, 20, 21, 22, 23, 24 or about 25 microns.

In some embodiments, the obtained slurry is preferably cast on the conductive metal foil to form a coating that surrounds the conductive metal foil with a thickness in the range of about 5 microns to about 20 microns, and more preferably in the range of about 7 microns to about 15 microns.

Suitable conductive metal foils may be selected from the following group of conductive metal foils consisting of titanium, copper, zinc, aluminium, iron, or any mixture thereof.

Good results were obtained when the slurry was cast on a Ti foil with a thickness of about 10 μm, followed by drying at 80° C. for 12 h in a vacuum furnace.

The mass loading of active electrode materials on Ti foils was ~2.5 mg cm⁻². Finally, Ti foils coated with electrode material slurries were cut into small pieces of 1.1 cm² in size using a punching machine.

The in-plane electrical conductivity of EMD cathodes fabricated using different carbon materials was examined by a four-point probe sheet resistance meter (Guardian SRM-232). The conductivity (σ, S m⁻¹) was calculated by σ=1/R_{S}t, where R_{S} (Ω/sq) is the sheet resistance, t is the thickness of electrode materials. The electrolyte absorption capability of carbon conductive additives was measured by immersing carbon electrodes (without EMD) fabricated using carbon materials (90 wt. %) and PVDF (10 wt. %) into the same volume of 1 M zinc sulfate (ZnSO₄) solution and recording the weight gain as a function of time.

### Zn—C Battery Assembly and Characterization

Coin cells (2032-type) were assembled using prepared EMD cathodes, Zn metal foil (1.1 cm²) as anodes, and 1 M ZnSO₄ solution as the electrolyte to evaluate their electrochemical performance. Galvanostatic charge/discharge (GCD) in a voltage range of 1.5- 0.7 V and electrochemical impedance spectroscopy (ES) measurements in a frequency range between 10⁶-0.008 Hz were collected using an electrochemical workstation (CHI 760D). The specific capacity of batteries was calculated based on the mass of EMD in cathodes. Galvanostatic intermittent titration technique (GITT) tests were carried out on assembled batteries using a battery testing system (LANHE) with a series of galvanostatic discharge pulses of 120 s at 50 mA g⁻¹ followed by a 4 h rest. Battery long-term stability tests were conducted using the battery testing system over a rest time of one month by continuously recording the open-circuit voltage (OCV). All electrochemical tests were performed at room temperature.

### Example 7: Summary of ECP Results

TABLE 5
Summary of ECP results

| | | | | | | Purity | Purity |
|---|---|---|---|---|---|---|---|
| Electrolyte 0.1M | | | Voltage | Time | | before | after |
| (temperature) | Anode | Cathode | (V) | (hr) | Membrane | (%) | (%) |
| (NH₄)₂SO₄ | Pt wire | graphite | 10.0 | 24 | NA (dialysis | 80.4 | 93.95 |
| (Room | | rod | | | bag) | | |
| temperature) | | | | | | | |
| (NH₄)₂SO₄ | Pt wire | graphite | 10.0 | 48 | NA (dialysis | 80.4 | 96.33 |
| (Room | | rod | | | bag) | | |
| temperature) | | | | | | | |
| FeSO₄ | Pt wire | graphite | 10.0 | 24 | NA (dialysis | 80.4 | 94.66 |
| (Room | | rod | | | bag) | | |
| temperature) | | | | | | | |
| H₂SO₄ | Pt wire | graphite | 10.0 | 24 | NA (dialysis | 80.4 | 94.55 |
| (Room | | rod | | | bag) | | |
| temperature) | | | | | | | |
| (NH₄)₂SO₄ | Pt wire | graphite | 10.0 | 24 | Black cloth | 80.4 | 94.05 |
| (Room | | rod | | | filter | | (95.21, |
| temperature) | | | | | | | after acid |
| | | | | | | | wash) |
| (NH₄)₂SO₄ | Lead alloy | graphite | 10.0 | 168 | Black cloth | 80.4 | 90.45 |
| (Room | (4% Sn, | rod | | | filter | | |
| temperature) | 1.75% Sb) | | | | | | |
| (NH₄)₂SO₄ | Pt coated | graphite | 10.0 | 72 | NA (dialysis | 80.4 | 96.26 |
| (Room | Ti | rod | | | bag) | | |
| temperature) | | | | | | | |
| (NH₄)₂SO₄ | Pt wire | graphite | 10.0 | 24 | NA (dialysis | 80.4 | 95.66 |
| (60° C.) | | rod | | | bag) | | |
| (NH₄)₂SO₄ | Pt wire | graphite | 10.0 | 48 | NA (dialysis | 87 | 98.35 |
| (Room | | rod | | | bag) | | |
| temperature) | | | | | | | |
| (NH₄)₂SO₄ | Pt wire | graphite | 10.0 | 48 | NA (dialysis | 84.2 | 98.88 |
| (Room | | rod | | | bag) | | |
| temperature) | | | | | | | |
| (NH₄)₂SO₄ | Pt wire | graphite | 10.0 | 48 | NA (dialysis | 98.88 | 99.48 |
| (Room | | rod | | | bag) | | (99.52 after |
| temperature) | | | | | | | acid wash) |
| 1.0M (NH₄)₂SO₄ | Pt wire | graphite | 10.0 | 48 | Black cloth | 98.35 | 99.52 |
| (Room | | rod | | | filter | | |
| temperature) | | | | | | | |
| 2.0M (NH₄)₂SO₄ | Pt wire | graphite | 6.0 | 24 | NA (dialysis | 84 | 96.03 |
| (Room | | rod | | | bag) | | |
| temperature) | | | | | | | |
| (NH₄)₂SO₄ | Pt wire | graphite | 10.0 | 168 | Black cloth | 90.94 | 99.71 |
| (Room | | rod | | | filter | | |
| temperature) | | | | | | | |
| (NH₄)₂SO₄ | Pt wire | graphite | 10.0 | 168 | NA (dialysis | 68 | 99.28 |
| (Room | | rod | | | bag) | | |
| temperature) | | | | | | | |
| (NH₄)₂SO₄ | Pt wire | graphite | 10.0 | 96 | NA (dialysis | 87 | 99.05 |
| (Room | | rod | | | bag) | | |
| temperature) | | | | | | | |
| (NH₄)₂SO₄ | Pt wire | graphite | 10.0 | 120 | Black cloth | 80.4 | 96.26 |
| (Room | | rod | | | filter | | |
| temperature) | | | | | | | |
| (NH₄)₂SO₄ | Pt wire | graphite | 10.0 | 48 | NA (dialysis | 96.26 | 97.20 |
| (Room | | rod | | | bag) | | |
| temperature) | | | | | | | |
| (NH₄)₂SO₄ | Pt wire | graphite | 10.0 | 48 | NA (dialysis | 70 | 93.93 |
| (Room | | rod | | | bag) | | |
| temperature) | | | | | | | |
| (NH₄)₂SO₄ | Pt wire | graphite | 10.0 | 48 | NA (dialysis | 93.93 | 96.05 |
| (Room | | rod | | | bag) | | |
| temperature) | | | | | | | |
| (NH₄)₂SO₄ | Pt wire | graphite | 10.0 | 48 | NA (dialysis | 70 | 96.96 |
| (Room | | rod | | | bag) | | |
| temperature) | | | | | | | |
| (NH₄)₂SO₄ | Pt wire | graphite | 10.0 | 48 | NA (dialysis | 96.96 | 98.22 |
| (Room | | rod | | | bag) | | |
| temperature) | | | | | | | |
| (NH₄)₂SO₄ | Pt coated | graphite | 10.0 | 240 | Black cloth | 90.37 | 97.44 |
| (Room | Ti | rod | | | filter | | |
| temperature) | | | | | | | |
| (NH₄)₂SO₄ | Pt wire | graphite | 10.0 | 48 | NA (dialysis | 97.44 | 97.88 |
| (Room | | rod | | | bag) | | |
| temperature) | | | | | | | |
| (NH₄)₂SO₄ | Pt wire | graphite | 10.0 | 48 | NA (dialysis | 90.37 | 97.27 |
| (Room | | rod | | | bag) | | |
| temperature) | | | | | | | |
| (NH₄)₂SO₄ | Pt wire | graphite | 10.0 | 48 | NA (dialysis | 97.27 | 97.97 |
| (Room | | rod | | | bag) | | |
| temperature) | | | | | | | |
| (NH₄)₂SO₄ | Pt coated | Pt coated | 10.0 | 240 | Black cloth | 90.37 | 97.62 |
| (Room | Ti | Ti | | | filter | (250 g) | |
| temperature) | | | | | | | |

### Example 8: Further Studies of ECP Process

Further studies were performed to explore different operating conditions that could affect the ECP process results. The studies were performed for 2 days with 20 g of graphite (66.54% purity, original sample), 0.1 M (if not otherwise stated) of (NH₄)₂SO₄ as electrolyte, black cloth filter bag, two Pt coated Ti electrodes and 10 V (if not otherwise stated).

### Electrolyte Stirring

For ECP process with electrolyte stirring (study 1a), the graphite purity was 96.2% compared to the one without stirring (study 1b).

### Bag Compression

For ECP process with black cloth filter bag compressed, the graphite purity was 96.2% compared to the one without compression (study 2).

### Voltage

For ECP process operating at 7 V (study 3a), the graphite purity was 94.2%. For those operated at 10 V and 20 V (study 3b), the purity was 96.2% and 98.8%, respectively.

### Electrolyte Concentration

For electrolyte at 0.1 M concentration, the graphite purity was 96.2%. For those operated with 0.5 M (study 4a) and 1.0 M (study 4b), the purity was 99.13% and 99.26%, respectively.

### Interelectrode Distance

For interelectrode distance of 5 cm (study 5), the graphite purity was 99.13%. For those operated at 10 cm, the purity was also 99.13%.

### Electrode Size

For electrode size of 1.5 cm×10 cm×25 μm, the graphite purity was 99.13. For those with electrode size of 2.5 cm×10 cm×25 μm (study 6), the purity was 99.27%.

### Reaction Duration

Samples were collected at regular time interval and analysed. Results are shown in Table 6 below. This study found that vast majority of purification occurs in the first 6 hours for this particular original sample.

TABLE 6
graphite purity at different reaction time

| Graphite | 0 min | 10 min | 60 min | 2 hr | 6 hr | 24 hr | 48 hr |
|---|---|---|---|---|---|---|---|
| purity, % | 66.54% | 80.37% | 83.26% | 92.24% | 96.92% | 98.96% | 99.43% |

### Influence of Operating Conditions on the Graphite Properties.

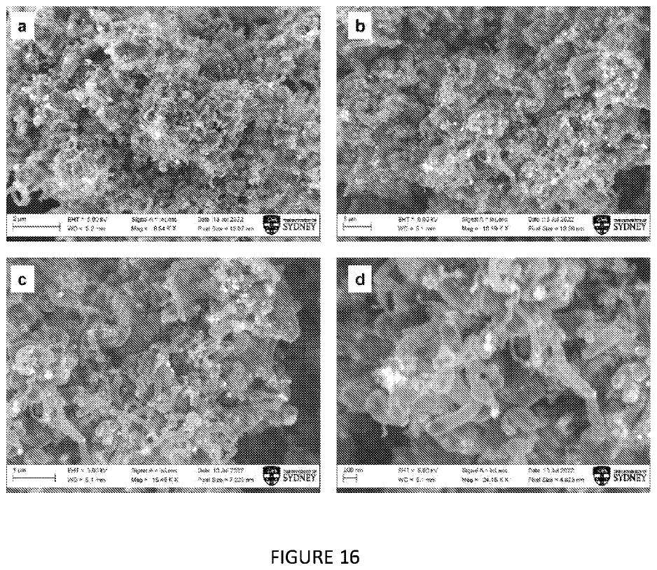

The morphology of the samples was examined by scanning electron microscopy (SEM, Zeiss, HD). The original carbon material (66.54% purity) was a mixture of different morphologies in micrometre-sized structure with numerous irregularities on their surfaces, including carbon nano onions (CNOs), carbon nanotubes (CNTs), and micro carbon shells (MCSs), as seen in FIG. 16. The bright spots observed in the FESEM images are Fe particles mostly coated with graphitic carbon from catalytic decomposition of methane reaction.

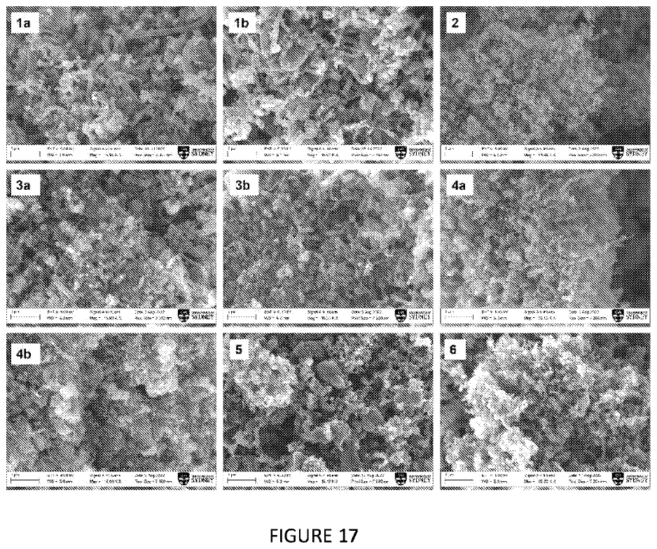

The morphology of the obtained samples from above studies were studied by FESEM. As illustrated in FIG. 17, the obtained morphologies have not shown any significant changes comparing to the original ones except that the bright spots indicative of Fe particles are sparser.

The average particle size of carbon materials dispersed in ethanol (5 mg/mL) was analyzed using a particle size analyzer according to the wet PSD instructions (Malvern Mastersizer 3000). As indicated in Table 7, the average particle size distribution is relatively small for all the ECP treated samples comparing to the original sample.

TABLE 7
The particle size distribution obtained from all the
samples using wet PSD via Malvern Mastersizer 3000

| | | study | study | study | study | study | study | study | study | study |
|---|---|---|---|---|---|---|---|---|---|---|
| | Original | 1a | 1b | 2 | 3a | 3b | 4a | 4b | 5 | 6 |
| Dx (10) μm | 4.71 | 0.449 | 0.472 | 0.885 | 0.337 | 0.404 | 0.235 | 0.318 | 0.424 | 0.665 |
| Dx (50) μm | 9.14 | 1.88 | 1.64 | 2.96 | 2.24 | 2.25 | 1.66 | 1.94 | 1.75 | 2.3 |
| Dx (90) μm | 15.9 | 9.48 | 6.85 | 7.59 | 9.02 | 9.54 | 6.89 | 7.05 | 8.16 | 8.76 |

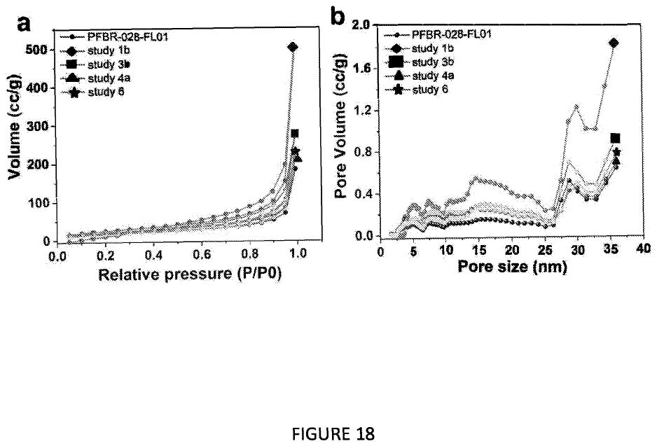

The surface area and pore structures of the original sample, and those ECP treated samples in which the variation of the operational parameter showed a significant change in the final purity levels were characterized by N2 physisorption using a pore size analyzer (Quantachrome Autosorb iQ). Density functional theory (DFT) method was used to calculate their pore size distribution from their N2 physisorption isotherms. The results for all tested samples are shown in FIGS. 18a and b. Their BET-specific surface area varies from 15.47 to 34 m2 g-1, following original<Study 6<Study 4b<Study 3b<Study 1b. Their pore size distribution determined by the DFT method is illustrated in FIG. 18, ranging from micropores (<2 nm) to macropores (>10 nm). It is noted that after electrochemical purification, the surface area increased due to the expansion and exfoliation of graphite layers.

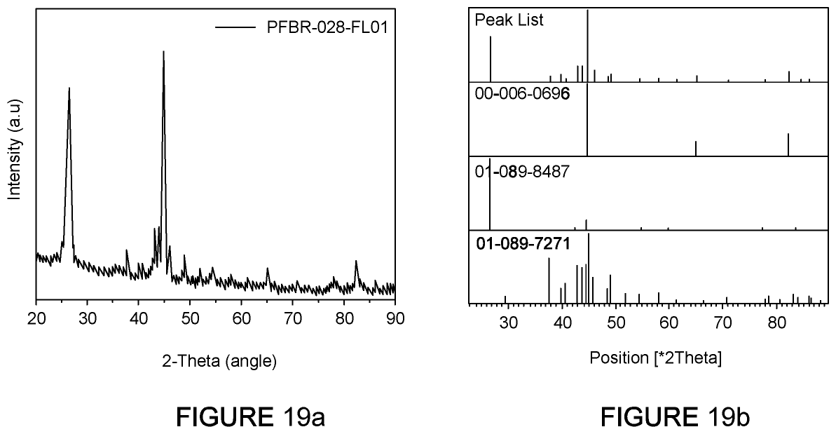

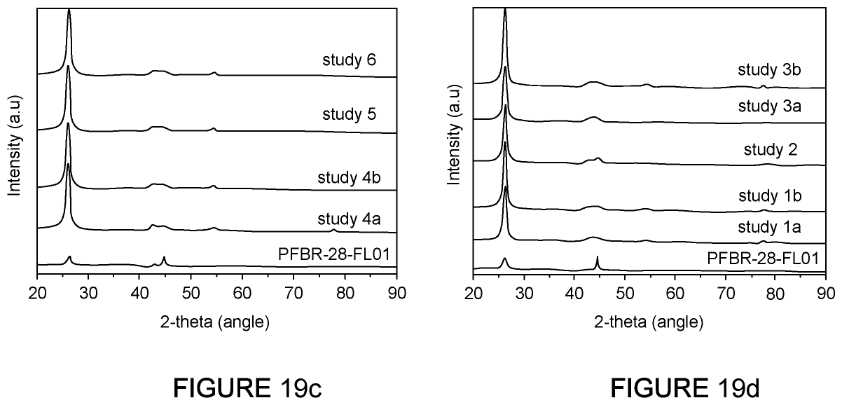

Finally, the influence of the ECP treatment on the structural changes of the graphite was investigated using X-ray diffraction (XRD) patterns via a diffractometer (Pananalytical Flat Plate powder XRD) under Cu-Kα radiation. The XRD pattern of the original sample is shown in FIG. 19a, with multiple diffraction peaks. The most intense peaks at 2θ=26.38° and 2θ=44.72° originate from graphitic carbon and metallic iron. In addition, several other diffraction peaks from metallic Fe and Fe₃C were also observed. The most intense Fe peaks are from metallic Fe (2θ=44.67, 65.02, and 82.33°, JCPDS No. 06-0696) and Fe₃C (2θ=37.64, 37.76, 42.89, 44.57, and 45.00°, as per JCPDS No. 89-7271). The XRD patterns of the ECP treated samples shown in FIGS. 19c and d indicate significant removal of Fe species from the graphite structure.

### Results and Discussion

### Properties of Carbon Materials

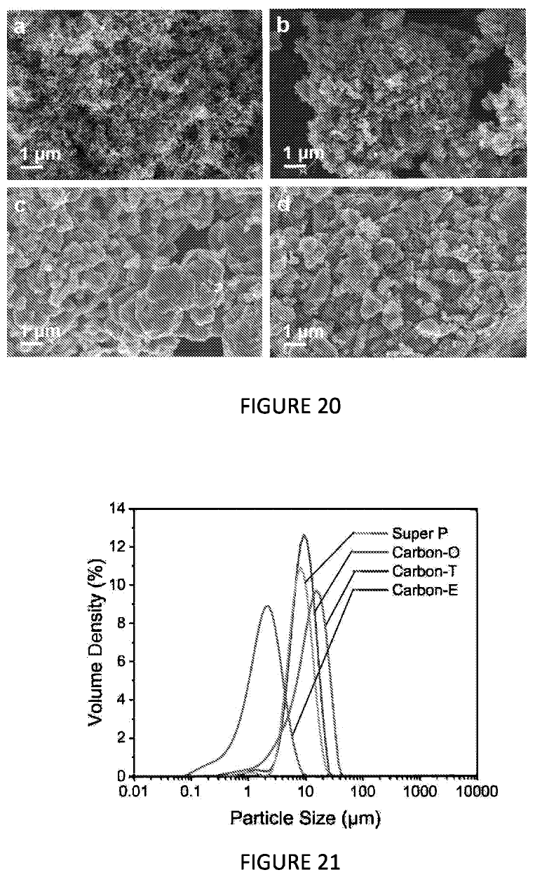

SEM images in FIG. 20 show the morphology of the four types of carbon materials (Super P, Carbon-O, Carbon-T, and Carbon-E). Super P displays a powdery and fine-grained morphology with particle sizes in nanometer scale, different from the other three graphitic carbon materials synthesized by CDM. Those carbon materials mainly consist of a micrometer-sized cloddy structure with numerous irregularities on their surfaces. Carbon-O shows a rougher surface topography, while Carbon-T and Carbon-E have relatively smoother surfaces formed by irregularly shaped particles made up of carbon flakes. Their average particle size was analysed using a particle size analyser. As shown in FIG. 21, when dispersed in an aqueous solution, Super P, Carbon-O, Carbon-T all have a similar median diameter (Dso) ranging from 9.1-12.4 μm. In comparison, Carbon-E has a smaller size of around 1.9 μm.

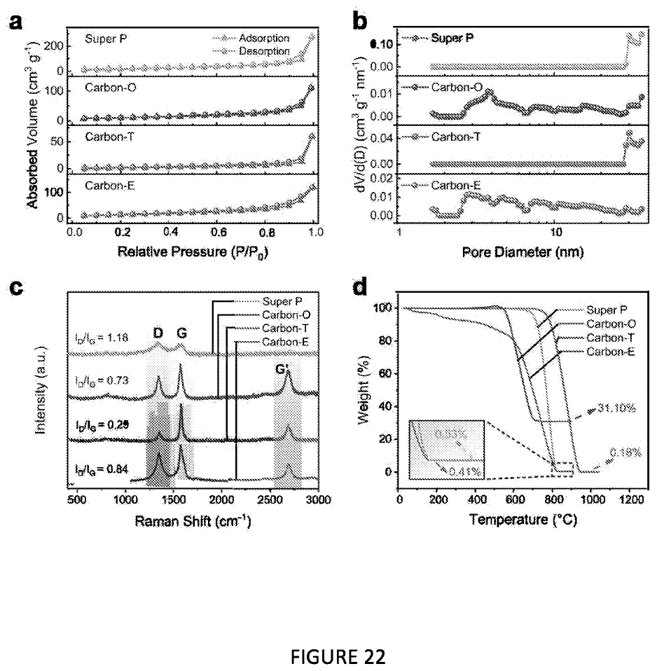

The specific surface area and pore structure of carbon materials were characterized by N₂ physisorption. FIG. 22a shows their N₂ physisorption isotherms. Their BET-specific surface area varies from 19-37 m² g⁻¹, following Carbon-T<Carbon-O<Carbon-E. Super P has a much larger surface area of 78 m² g⁻¹. Their pore size distribution determined by the DFT method is illustrated in FIG. 22b. Super P has the largest pore volume of 1.83 cm³ g⁻¹ with an average pore size of 36 nm, indicating its mesoporous nature. Carbon-O and Carbon-E exhibit broad pore size distributions ranging from micropores to macropores. The pore volume and average pore size of Carbon-O and Carbon-E are similar at 0.13 cm³ g⁻¹, 3.8 nm, and 0.15 cm³ g⁻¹, 2.9 nm, respectively, which indicates that the electrochemical purification process does not significantly change the porous structure of Carbon-O. In contrast, Carbon-T shows a pore size distribution centred around 30.1 nm and a larger pore volume at 0.30 cm³ g⁻¹. The disappearance of small pores in Carbon-T and the increased pore volume may be related to the complete removal of metal residues encapsulated in carbon and the restructuring and closing of small pores at high temperatures.

The chemical structure of carbon materials was first analysed by Raman spectroscopy. FIG. 22c shows their Raman spectra with three typical carbon material features: G band corresponding to zone centre vibration of carbon atoms in graphene planes, D band associated with the disorder in a graphitic lattice, and G′ band related to the number of graphene layers and their stacking order. Super P only displays D and G bands, suggesting a lack of long-range graphitic structures. The intensity ratio of D and G bands (I_{D}/I_{G}) can be correlated to defects, structural vacancies, and surface functional groups in carbon materials. The I_{D}/I_{G} of Super P is 1.18, which is higher than Carbon-O at 0.73, Carbon-E at 0.84, and Carbon-T at 0.29. These results indicate that Carbon-T has the lowest level of defects due to its high-temperature treatment condition. In contrast, Carbon-E has a relatively higher concentration of defects due to the exfoliation of graphene layers during purification. Super-P has the most defective structure.

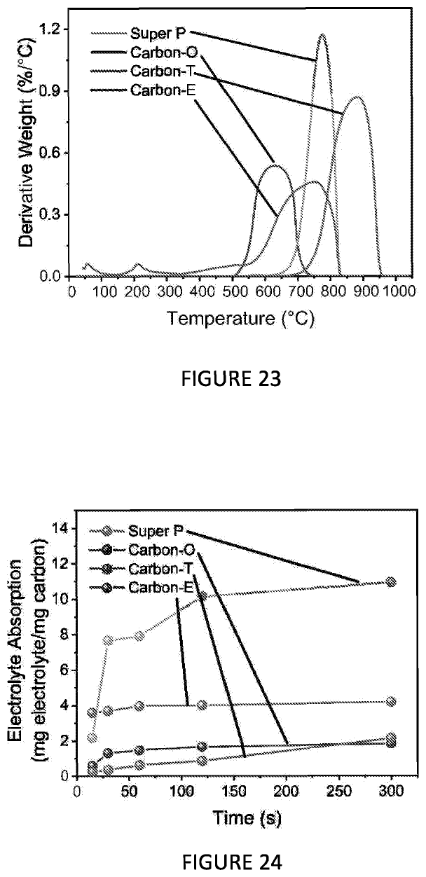

Their chemical structures and metal residues were further examined by TGA. FIG. 22d and its inset show their weight loss profiles in the air when the temperature increases from 25 to 900° C. (25 to 1040° C. for Carbon-T due to its higher thermal stability). Derivative thermogravimetry (DT) profiles are shown in FIG. 23. The primary weight loss of Carbon-T takes place at the highest temperature at 882° C., suggesting the highest graphitic level. The central weight loss temperature of Super P at 776° C. is also higher than those of Carbon-E and Carbon-O. The main weight loss temperature of Carbon-O is the lowest at 632° C., attributing to the oxidative decomposition of carbon catalysed by Fe residues. Further, Carbon-E has some weight loss starting from 48° C., originating from volatile components formed during its electrochemical purification. Carbon-T has the lowest ash content of 0.18 wt. %, indicating the highest carbon purity of 99.82 wt. %. Carbon-E and Super P also have a high purity of 99.59 wt. % and 99.47 wt. %, respectively. Carbon-O has the top ash content of 31.10 wt. %. XRF was used to analyse the chemical composition of the ash residues obtained after TGA.

As listed in Table 8, Fe₂O₃ counts for 95.32 wt. % of the ash, formed by oxidation of Fe residues encapsulated in carbon materials. The purity of Carbon-O is estimated to be 78.25 wt. %.

TABLE 8
XRF analysis of Carbon-O ash composition
after combustion at 900° C. for TGA test (left),
and XRF analysis of Fe ore catalyst used
for CDM process (right).

| | Composition | | Composition |
|---|---|---|---|
| Oxides | (wt. %) | Oxides | (wt. %) |
| Fe₂O₃ | 95.32 | Fe₂O₃ | 88.00 |
| Al₂O₃ | 2.9 | Al₂O₃ | 1.16 |
| SiO₂ | 1.03 | SiO₂ | 3.34 |
| P₂O₅ | 0.32 | P₂O₅ | 0.28 |
| Na₂O | 0.12 | Na₂O | 0.24 |
| TiO₂ | 0.02 | TiO₂ | 0.08 |
| Mn₃O₄ | 0.01 | MgO | 0.20 |
| MgO | <0.01 | CaO | 0.02 |
| CaO | <0.01 | Loss on | 5.95 |
| | | ignition | |
| | | at 1,050° C. | |

### Properties of Fabricated Electrodes

The different carbon materials were used as conductive additives at the same mass ratio to fabricate EMD electrodes. The electrical conductivity of fabricated electrodes may be influenced by multiple factors, such as graphitic structures of carbon additives and their particle size, surface area, and porosity.

The inventors observed that the in-plane electrical conductivity of EMD electrodes fabricated using these materials fell within the range of about 70 S m⁻¹ to about 100 S m⁻¹. For example, the in-plane electrical conductivity of these particular EMD electrodes may fall within the range of about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or about 100 S m⁻¹. In some embodiments, the in-plane electrical conductivity of these particular EMD electrodes preferably falls within the range of about 80 S m^{- 1} to about 95 S m⁻¹, m more preferably about 90 S m⁻¹.

For instance, as shown in Table 9, the in-plane electrical conductivity of EMD electrodes fabricated using Super P is the lowest at 72 S m⁻¹, which can be ascribed to its porous and defective structures. In comparison, the EMD electrodes fabricated using the two purified carbon materials, i.e., Carbon-T and Carbon-E, have a similar electrical conductivity of 98 and 90 S m⁻¹, respectively. The higher electrical conductivity is correlated with their more graphitic characteristics, as shown in Raman results. The pore size difference between Carbon-T and Carbon-E seems not to affect the electrical conductivity significantly. The larger surface area of Super P also does not bring beneficial effects on the electrical conductivity of electrodes. The electrode fabricated using Carbon-O has the highest electrical conductivity of 143 S m⁻¹, which may be related to its substantial fraction of Fe residues, considering that it has a higher I_{D}/I_{G} ratio and similar specific surface area and average pore size as Carbon-E.

TABLE 9
A summary of physiochemical properties of carbon materials, the electrical conductivity
of EMD/carbon electrodes, and electrolyte absorption capacity of carbon electrodes.

| | | | | | | TGA | | | |
|---|---|---|---|---|---|---|---|---|---|
| | | | | | | main | | | Electrolyte |
| | Median | Specific | Total | Average | | peak | | Electrode | absorption |
| | diameter | surface | pore | pore | | temper- | Carbon | conduc- | capacity |
| Carbon | [symbol] | area (m² | volume | size | Raman | ature | purity | tivity | (mass |
| materials | (μm) | g⁻¹) | (cc g⁻¹) | (nm) | I_{D}/I_{G} | (° C.) | (wt. %) | (S m⁻¹) | ratio) |
| Super P | 9.1 | 78 | 1.83 | 36.0 | [symbol] | 776 | 99.47 | 72 | 10.94 |
| Carbon-O | 9.3 | 30 | 0.13 | 3.8 | 0.73 | 632 | 78.25 | 143 | 1.54 |
| Carbon-T | 12.4 | 19 | 0.30 | 30.1 | 0.29 | 882 | 99.52 | [symbol] | 2.14 |
| Carbon-E | 1.9 | 37 | 0.15 | 2.9 | 0.84 | 749 | [symbol] | 90 | 4.20 |

[symbol]

indicates data missing or illegible when filed

Another essential function of carbon conductive additives is absorbing and holding electrolytes to maintain stable solid-liquid interfaces in electrodes. However, extremely high electrolyte capacity would consume more electrolytes, increasing battery manufacture costs. The electrolyte absorption capacity is influenced by carbon additives' pore volume, pore size, and surface area. FIG. 24 shows the electrolyte uptake by the different types of carbon materials (in the unit of mg electrolyte per mg carbon) in 5 min when carbon electrodes are immersed in 1 M ZnSO₄ solution. The substantially larger specific surface area and pore volume of Super P led to faster electrolyte update and the highest absorption capacity of 10.94, about 6 times that of Carbon-O at 1.84 after 5 min. The electrolyte absorption capacity of Carbon-T at 2.14 and Carbon-E at 4.20 are both higher than that of Carbon-O.

### Properties of Assembled Zn/C Batteries

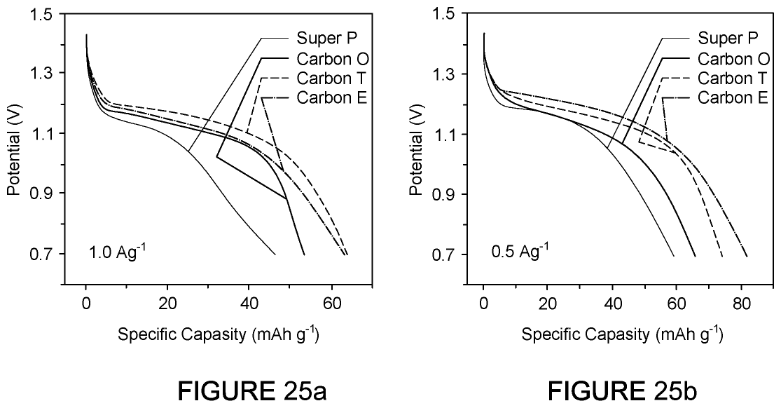

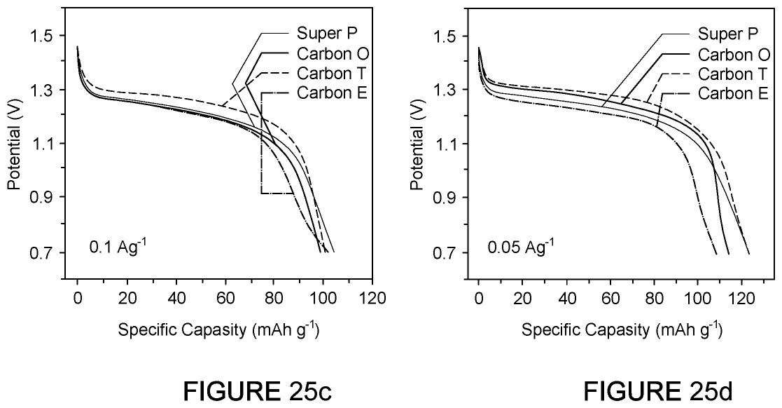

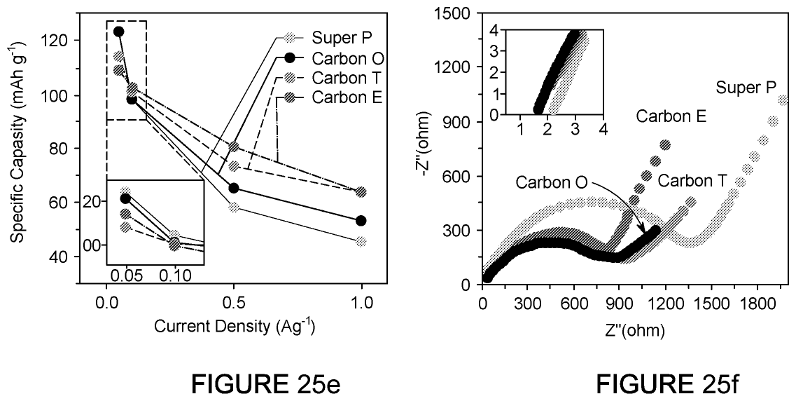

Next Zn/C batteries were assembled using EMD cathodes fabricated with different carbon conductive additives and Zn metal anodes in 1 M ZnSO₄ aqueous electrolyte. FIGS. 25a-d show their galvanostatic discharge curves in the voltage window of 1.5-0.7 V under current densities of 1.0, 0.5, 0.1, and 0.05 A g⁻¹, respectively. All discharge curves feature a typical discharge behaviour of Zn—C batteries with an ohmic voltage drop (IR drop) at the beginning of discharge to a flat discharge plateau, followed by a voltage decrease to the cut-off voltage. Under high current densities of 1.0 and 0.5 A g⁻¹, Zn—C cells containing graphitic carbon materials synthesized by CDM show significantly higher specific discharge capacities than that containing Super P. The Carbon-T cell delivers a specific capacity 1.4 times that of the Super P cell at 1.0 A g⁻¹. In comparison, minor differences were observed under the lower current density of 0.1 A g⁻¹. The specific capacity varies from 99 to 104 mAh g⁻¹ in a sequence of Carbon-O cell<Carbon-T cell<Carbon-E cell<Super P cell. Under the lowest current density of 0.05 A g⁻¹, the specific capacity of the Carbon E cell typically falls within a range of between about 50 mAh g⁻¹ to about 200 mAh g⁻¹, preferably between about 70 mAh g⁻¹ to about 120 mAh g⁻¹, and more preferably about 109 mAh g⁻¹, when measured between 1.5 V and 0.7 V under a current density of 0.05 A g⁻¹. This result compares with the specific capacities of each of the Carbon-O and Carbon-T, which were measured to be 122 and 114 mAh g⁻¹, respectively, comparable to the Super P cell at 124 mAh g⁻¹.

FIG. 25e compares their specific capacity under different discharge current densities. All batteries experience a capacity decrease with the increase of discharge current density from 0.05 to 1.0 A g⁻¹, particularly the Super P cell exhibits the most significant drop. FIG. 25f shows Nyquist plots of EIS spectra of the Zn—C batteries. The intercept of the impedance curve with the real axis denotes ohmic resistance.

As displayed in FIG. 25f inset, the Super P cell shows a larger ohmic resistance, consistent with its lower measured in-plane electrical conductivity of the EMD electrode. Negligible differences were observed in the ohmic resistance of Carbon-T, Carbon-E, and Carbon-O cells. Further, based on the semicircles in the high-frequency region, Carbon-T, Carbon-E, and Carbon-O cells have much lower charge transfer resistance than the Super P cell. Previous studies have reported that the network of carbon conductive additives may not fully cover all EMD particles due to Super P particle agglomeration. In contrast, the other three types of carbon particles seem to fill the gaps between EMD particles more efficiently. The charge transfer resistance of the Carbon-O cell is close to that of Carbon-T, and Carbon-E cells, suggesting that Fe residues in Carbon-O have negatable roles in facilitating electron transfer at electrode/electrolyte interfaces, despite the higher in-plane conductivity of EMD electrodes fabricated using Carbon-O.

Overall, Zn—C batteries fabricated using the graphitic carbon materials synthesized by CDM perform better than those fabricated using Super P under high discharge current densities and are comparable under low discharge current densities. The improved performance at high discharge rates is related to the higher electrical conductivity of the CDM synthesized carbon materials and the effective electronic networks formed by them in batteries.

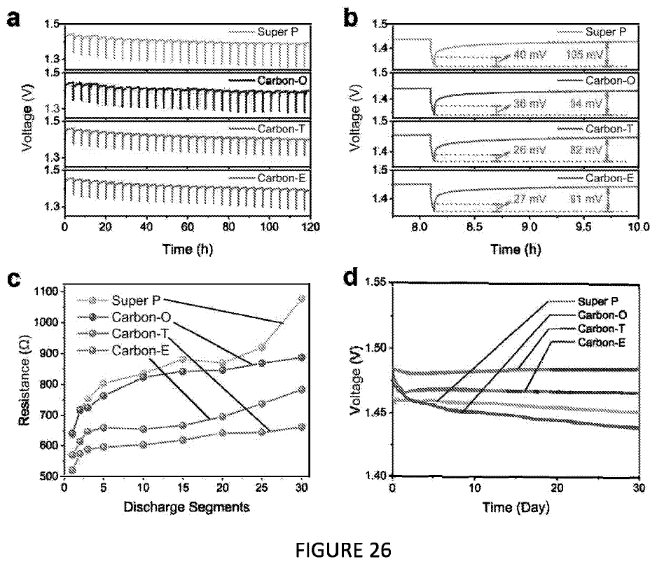

We further utilized the GITT technique to investigate the voltage response of Zn—C batteries under intermittent operation conditions, which is more relevant for their practical working conditions. As shown in FIG. 26a, all cells are discharged under 0.05 A g⁻¹ for 120 s followed by a 4 h rest, and this test cycle was repeated for 30 segments. FIG. 26b shows the enlarged region of the GITT fragment at the 3rd test cycle, displaying the voltage relaxation process during the rest time. The instant voltage jump (IR drop) is correlated with ohmic and charge transfer resistance. The followed gradual voltage change is associated with ion diffusion. Carbon-T and Carbon-E cells exhibit smaller IR drops of 26 and 27 mV, respectively, indicating lower internal resistances. The total voltage changes of Super P, Carbon-O, Carbon-T, and Carbon-E cells are 105, 94, 82, and 91 mV, respectively, showing a similar trend as their IR drops. The smallest voltage change of the Carbon-T cell can be attributed to its lowest resistance and better ion diffusion. The internal resistances of all cells increase with extended test time, which was calculated by Ohm's law, i.e., R=V/I, where V (V) is the maximum voltage change in one segment, I (A) is the discharge current.

As shown in FIG. 26c, the Super P cell has the highest cell resistance and the fastest increasing rate, while the Carbon-T cell shows the lowest cell resistance and lowest increasing rate over the entire GITT segments.

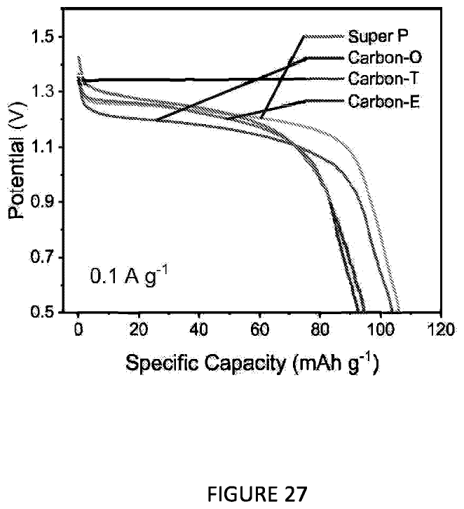

FIG. 26d compares the long-term stability of the Zn—C batteries fabricated using different carbon conductive additives over one month. The Carbon-O cell exhibits the largest OCV drop of 0.037 V, attributed to Fe residuals in Carbon-O, causing self-discharge or secondary reactions. In contrast, the Carbon-T and Carbon-E cells show negligible OCV drop of 0.001 and 0.020 V, respectively, better than the Super-P cell at 0.014 V. Their improved stability indicates that both purification methods have successfully removed Fe residues to avoid their detrimental effect on battery long term performance. After the stability test, all Zn—C cells were galvanostatically discharged at 0.1 A g⁻¹ to evaluate their discharge characteristics after a long-term placement. FIG. 27 shows that discharge curves of Zn—C batteries are similar, with a specific capacity of around 95 mAh g⁻¹ when discharging to 0.7 V.

### CONCLUSION

Graphitic carbon materials (Carbon-O) were synthesized by CDM using Fe ores as catalysts as a co-product of H₂. They were purified by the standard high-temperature thermal treatment at 2800° C. (Carbon-T) and the alternative electrochemical method (Carbon-E), increasing their carbon purity from 78.25 to 99.82 and 99.59 wt. %, respectively. They were evaluated as conductive carbon additives for Zn—C batteries. MnO₂ cathodes fabricated using Carbon-T or Carbon-E at the mass ratio of 7:2 show electrical conductivity of 98 and 90 S cm⁻¹, and their carbon electrodes have the electrolyte (1 M ZnSO₄) absorption capacity of 2.14 and 4.20 mg mg⁻¹, respectively. Zn—C batteries assembled using Carbon-T or Carbon-E exhibit the specific capacity of 114, and 109 mAh g⁻¹ under 0.05 A g⁻¹, comparable to that with commercial carbon conductive additives (Super P). Importantly, they demonstrate better rate performance when the current density increases from 0.05 to 1.0 A g⁻¹ due to their high electrical conductivity resulting from their graphitic structures. They also exhibit excellent performances under intermittent operation conditions and in long term stability tests because the efficient removal of their Fe residues has prevented self-discharge behaviours. There is no significant difference between Carbon-T and Carbon-E, indicating both purification methods are efficient. Purified graphitic carbon materials from CDM are promising as efficient carbon conductive additives for batteries, which turn solid wastes from CDM into high a value-added commodity, increasing the economic viability of CDM-based H₂ production process.

### Key Features of the Present Invention

The present investigation has brought forth several key findings, which may be summarised as follows:

The ECP process works for graphite slurry; the graphite slurry has less conductivity than the packed graphite; correspondingly, the rate of reaction is reduced; the distance between the electrodes for the ECP process will affect the rate of reaction and is a major design consideration; increasing the voltage is roughly proportional to an increase of the reaction rate.

In respect of the viability of separating the iron by-product: The iron by-product is an iron salt complex, such as ammonium jarosite; the iron by-product cannot be easily separated from the graphite by physical separation techniques like centrifugation; the iron by-product can be dissolved in H₂SO₄ as an alternative washing step.

In respect of the electrolyte: H₂SO₄ and FeSO₄ were tested as alternative electrolytes; the performance of both alternative electrolytes was comparable to that of (NH₄)₂SO₄; all electrolytes were able to purify graphite from the pilot plant with initial purity of 80% up to over 93%; H₂SO₄ does not produce observable solid by-products, however it produces a high amount of H₂ and O₂ at the electrodes; when using FeSO₄ as an electrolyte, iron from both the electrolyte and the graphite can be recovered at the cathode.

Finally, a Zn/C battery fabricated with a negative electrode comprising a metal foil substrate coated with the purified graphitic material produced via the ECP process, had a specific discharge capacity of at least about 109 mAh g⁻¹, when measured between 1.5 V and 0.7 V under a current density of 0.05 A g⁻¹.

Those skilled in the art will appreciate that the invention described above is susceptible to variations and modifications other than those specifically described. It is understood that the invention includes all such variations and modifications which fall within the spirit and scope of the present invention.

Future patent applications may be filed in Australia or overseas on the basis of or claiming priority from the present application. It is to be understood that the following provisional claims are provided by way of example only and are not intended to limit the scope of what may be claimed in any such future application. Features may be added to or omitted from the provisional claims at a later date so as to further define or re-define the invention or inventions.

1. A process for purifying graphitic material, the process comprising:
electrochemically treating a crude graphitic material comprising an impurity selected from a metal, metal oxide and combinations thereof;
using a predetermined electrolyte;
over a predetermined period;
over a predetermined voltage range;
over a predetermined temperature range;
using a predetermined anode composition;
using a predetermined cathode composition;
thereby removing a portion of the impurity as a result of the electrochemical treatment and providing a purified graphitic material.

2. A process according to claim 1, further comprising a predetermined semipermeable membrane to protect the cathode from short-circuiting upon contacting the graphitic material.

3. A process according to claim 1 or claim 2, wherein the purified graphitic material has a morphology substantially the same as that of the crude graphitic material, wherein the graphitic material has a morphology selected from graphitic fibres (including carbon nano-tubes), carbon nano-onions, carbon micro-spheres and graphene.

4. A process according to any one of the preceding claims, wherein the impurity is selected from metals, metal oxides and combinations thereof.

5. A process according to claim 4, wherein the impurity is selected from iron, elemental iron, iron oxides, iron-carbon species such as ferrite, austenite or cementite, and combinations thereof.

6. A process according to any one of the preceding claims, wherein the electrolyte is ammonium sulfate, iron sulfate, nitric acid, sulfuric acid or a mixture thereof.

7. A process according to claim 5 or claim 6, wherein the iron impurity deposits as elemental iron on the cathode, precipitates as iron hydroxide or iron complex or remains in solution.

8. A process according to any one of the preceding claims, wherein the voltage range is between about 1 V and 300 V, preferably between about 5 V and 300 V.

9. A process according to any one of the preceding claims, wherein the period is between about 2 h and about 2 weeks, preferably between about 2 h and 96 h.

10. A process according to any one of the preceding claims, wherein the temperature range is between about 5° C. and about 100° C.

11. A process according to any one of the preceding claims, wherein the cathode comprises one or more metal, metal alloy plates, platinum, or titanium coated with platinum, and wherein the anode comprises graphite, lead, lead alloys, platinum, titanium coated with platinum and combinations thereof.

12. A process according to claim 11, further comprising the use of a permeable membrane covering at least a portion of the anode, cathode, or both, wherein the permeable membrane is a neutrally-charged permeable membrane, an anion exchange membrane, or a cation exchange membrane, and wherein the permeable membrane has a molecular weight cut-off (MWCO) of less than about 1 million Da, and preferably between about 10 kDa, and about 0.5 kDa.

13. A process according to claim 12, wherein the permeable membrane has an air permeability of between 0.1 and 100 L/min/dm² at 200 Pa.

14. A process according to any one of the preceding claims, wherein the purified graphitic material has a purity of greater than about 95% w/w, preferably greater than about 99% w/w, more preferably greater than about 99.5% w/w, still more preferably greater than about 99.95% w/w.

15. A process according to any one of the preceding claims, wherein the crude graphitic material is slurried prior to the electrochemical treatment process.

16. A process according to any one of the preceding claims, wherein the rate of purification reaction is proportional to the voltage applied.

17. A purified graphitic material, obtained or obtainable from a process as defined according to any one of the preceding claims.

18. A negative electrode material comprising a coating on a substrate, the coating comprising:
MnO₂ (electrolytic manganese dioxide (EMD)), a carbon conductive additive in the form of purified graphitic material according to claim 17, and a binder.

19. An electrode according to claim 18, wherein the EMD is one or more of α-, β-, γ-, δ-, or λ-MnO₂.

20. An electrode according to claim 18 or claim 19, wherein the EMD, the carbon conductive additive and the binder are mixed together in a weight ratio of 4-9:2:1.

21. An electrode according to any one of claims 18 to 20, wherein the binder is selected from the group consisting of polyvinylidene fluoride (PVDF), polytetrafluoroethylene (PTFE), fluorinated ethylene propylene (FEP), perfluoroalkoxyl polymer (PFA), polyvinyl fluoride (PVF), carboxymethyl cellulose (CMC), sodium alginate, starch, styrene-butadiene rubber (SBR), xanthan gum, polyvinyl chloride (PVC), polyacrylic acid (PAA), polyvinyl alcohol (PVA), polyethylene glycol (PEG), and polyamide imide (PAI).

22. An electrode according to any one of claims 18 to 21, wherein the substrate comprises a metal foil made of a conductive foil selected form the group consisting of copper, zinc, aluminium, iron, or any mixture thereof.

23. An electrode according to any one of claims 18 to 22, wherein the coating at least partially surrounds the substrate, and wherein the coating has a thickness in the range of about 1 micron to about 25 microns.

24. An electrode according to any one of claims 18 to 23, wherein the negative electrode has an electrical conductivity that falls within a range of about 70 S m⁻¹ to about 100 S m⁻¹.

25. A battery comprising:
a positive electrode;
a negative electrode; and
an electrolyte in contact with the positive electrode and the negative electrode,
wherein the negative electrode comprises a coating on a substrate, and wherein the coating comprises MnO₂ (electrolytic manganese dioxide (EMD)), a carbon conductive additive in the form of purified graphitic material according to claim 17, and a binder.

26. A battery according to claim 25, wherein the EMD is one or more of α-, β-, γ-, δ-, or λ-MnO₂.

27. A battery according to claim 25 or claim 26, wherein the EMD, the carbon conductive additive and the binder are mixed together in a weight ratio of 4-9:2:1.

28. A battery according to any one of claims 25 to 27, wherein the binder is selected from the group consisting of polyvinylidene fluoride (PVDF), polytetrafluoroethylene (PTFE), fluorinated ethylene propylene (FEP), perfluoroalkoxyl polymer (PFA), polyvinyl fluoride (PVF), carboxymethyl cellulose (CMC), sodium alginate, starch, styrene-butadiene rubber (SBR), xanthan gum, polyvinyl chloride (PVC), polyacrylic acid (PAA), polyvinyl alcohol (PVA), polyethylene glycol (PEG), and polyamide imide (PAI).

29. A battery according to any one of claims 25 to 28, wherein the substrate comprises a metal foil made of a conductive metal selected from the group consisting of copper, zinc, aluminium, iron, or any mixture thereof.

30. A battery according to any one of claims 25 to 29, wherein the coating at least partially surrounds the substrate, and wherein the coating has a thickness in the range of about 1 micron to about 25 microns.

31. A battery according to any one of claims 25 to 30, wherein the negative electrode has an electrical conductivity that falls within a range of about 70 S m⁻¹ to about 100 S m⁻¹.

32. A battery according to any one of claims 25 to 31, wherein the electrolyte is an aqueous electrolyte present in a concentration that falls within the range of about 0.01 M to about 10.0 M.

33. A battery according to any one of claims 25 to 32, wherein the electrolyte is an aqueous electrolyte selected from the group consisting of an ammonium sulfate, sodium sulfate, magnesium sulfate, iron sulfate, copper sulfate, zinc sulfate (ZnSO₄), zinc chloride (ZnCl₂), zinc trifluoromethyl sulfonate (Zn(CF₃SO₃)₂), cadmium nitrate, cobalt nitrate, sodium nitrate, sodium chloride, nickel chloride, potassium chloride, ammonium chloride (NH₄Cl), calcium chloride, sulfuric acid, and combinations thereof.

34. A battery according to any one of claims 25 to 33, wherein the electrolyte is an ionic liquid comprising a cation selected from the group consisting of 1-alkyl-3-methyl-imidazolium, N-alkyl-pyridinium, tetraalkyl-ammonium, tetraalkyl-phosphonium, 1-ethyl-3-methyl-1H-imidazolium, 1-butyl-3-methyl-1H-imidazolium, 1-butylpyridinium, and combinations thereof, wherein the alkyl group is selected from the group consisting of C₂-C₁₂ alkyl.

35. A battery according to any one of claims 25 to 34, wherein the electrolyte is ZnSO₄, present in a concentration that falls within the range of about 0.01 M to about 10 M.

36. A battery according to any one of claims 25 to 35, wherein the positive electrode is a zinc metal electrode.

37. A battery according to any one of claims 25 to 36, wherein the negative electrode has a specific discharge capacity that falls within a range of between about 50 mAh g⁻¹ to about 200 mAh g⁻¹, when measured between 1.5 V and 0.7 V under a current density of 0.05 A g⁻¹.
